(19) United States
(12) Patent Application Publication
(10) Pub. No.: US 2002/0161611 A1
(43) Pub. Date: Oct. 31, 2002

(54) Method and system for communication with groups associated with requests for action

(76) Inventors: Morgan N. Price, Scotts Valley, CA (US); Harry Max, Los Gatos, CA (US); J. Andrew Freeman, San Jose, CA (US); Emil Jandourek, San Jose, CA (US)

Correspondence Address: HAYNES BEFFEL & WOLFELD LLP, P O BOX 366, HALF MOON BAY, CA, 94019, US

(21) Appl. No.: 09/776,334

(22) Filed: Feb. 2, 2001

(51) Int. Cl. G06F 17/60; G06F 7/00

(52) U.S. Cl. 705/7; 707/6; 707/10

(57) ABSTRACT

A platform provides for interaction with customers or other classes of individuals on a group basis. The platform supports a method that includes maintaining data about groups of persons, wherein the groups include persons associated with respective requests for action. The data further includes information sufficient to contact members of the groups. The platform provides a client interface, such as a web page for use of the data about groups of persons and requests for action. Using the client interface, users find and become members of groups. The platform also provides a business user interface, such as a web page, for use of the data about groups and about requests for action, by which business users monitor activity of groups and communicate with the groups. The client interface includes tools for browsing a set of requests for action, selecting a particular request, and joining a group of persons associated with the particular request. Further, the client interface includes a tool for composing and submitting a request for action, and comments associated with a selected request for action. The business user interface includes a tool for browsing a set of requests for action, selecting a particular request, and accessing information about a group of persons associated with the particular request. Such information about a group includes statistics such as the number of people who have joined in the request, the identity of such persons, any comments such persons have submitted, and related requests. The business user interface also includes the tool for composing and submitting a response to particular request for action. The response includes an offer directed to satisfaction of the request for action in some instances, and in other instances consists of only a communication with the members of the group.

### BACKGROUND OF THE INVENTION

1. Field of the Invention

The present invention relates to systems and methods for interacting with groups of clients using a communication network such as the Internet. More particularly, embodiments of the present invention provide for management of customer service functions based upon groups of individuals associated with requests and business users managing responses to such requests on a group basis.

2. Description of Related Art

Customer service is a particularly complex area of business technology, and the ability of a company to meet the needs of customers and to provide the support required to keep customers satisfied lie at the core of any business. However, identifying and meeting the needs and providing support services that are important to a customer base, are difficult problems that rely on effective communication with the customer base.

One example technology for managing customer service is the so called, Frequently Asked Question (FAQ) system. FAQ systems associate questions commonly asked about a subject with answers. This architecture is often embodied with a search mechanism used to help the user find appropriate questions. However, these systems are only useful for one-way communication. So-called dynamic FAQs have been developed to address some of these limitations. A dynamic FAQ is an automatically maintained FAQ where new questions and answers are added and sorted/categorized/searched automatically. Some dynamic FAQ's integrate with the email response system and add the message/response to the FAQ if the company desires. However, even dynamic FAQ's do not provide efficient solutions to customer's problems.

Other techniques include the use of call centers or email communications by which customers contact customer service representatives, for one on one interaction. The responses to the customer communications can be automated in some cases, but are typically provided by a live person. Obviously, this approach is expensive and limited, because of the requirement to train customer service representatives, and the inability to provide them with broad authority to craft satisfying responses to a large variety of possibly unexpected requests.

Accordingly, it is desirable to provide systems and methods that facilitate interaction and communication between businesses or other organizations, with customers or other groups of persons that seek actions, goods or services from such organizations as solutions to the customer's problems, or in satisfaction of other wants of customers.

### SUMMARY OF THE INVENTION

The present invention provides a platform for interaction with customers or other classes of individuals on a group basis. The platform provides a method that includes maintaining data about groups of persons, wherein the groups include persons associated with respective requests for action. The data further includes information sufficient to contact members of the groups. The platform provides a client interface, such as a web page for use of the data about groups of persons and requests for action. Using the client interface, clients find and become members of groups. The platform also provides a business user interface in some embodiments, such as a web page, for use of the data about groups and about requests for action, by which business users monitor activity of groups, communicate with the groups, and when appropriate, make offers directed to satisfying the requests for action. Responses to requests for action which include offers, allow the clients to accept the offer, and optionally provide tools such as links to transactional pages, by which satisfaction of the accepted offer can be obtained.

A request for action is distinguished from a basic question as used in FAQ systems. For example, “How do I return a defective item?” is a simple question. “I want a refund on the purchase of product X,” is a request for action, expressed in the form of a demand, that cannot be reduced to a simple question that could be handled by a FAQ system.

According to one embodiment, the client interface includes tools for browsing a set of requests for action, selecting a particular request, and joining a group of persons associated with the particular request. Further, the client interface includes a tool for composing and submitting a request for action in some embodiments. In another embodiment, the client interface includes a tool for composing and submitting a comment associated with a selected request for action.

In another embodiment, the business user interface includes a tool for browsing a set of requests for action, selecting a particular request, and accessing information about a group of persons associated with the particular request. Such information about a group includes statistics such as the number of people who have joined in the request, the identity of such persons, any comments such persons have submitted, and related requests. The business user interface also includes the tool for composing and submitting a response to particular requests for action. The response includes an offer directed to satisfaction of the request for action in some instances, and in other instances consists of only a communication with the members of the group.

According to one aspect of the invention, responses sent from business users to members of a group included tools by which members of the group that receive the offer indicate acceptance or rejection of the offer. Another embodiment, in addition to acceptance or rejection of the offer, includes a tool by which members that receive an offer may indicate a level of satisfaction with the offer, and with responses that may not include offers. Information about the number of acceptances and rejections, and the level of satisfaction indicated by members of the group, is presented to business users for analysis of the request for action and solutions presented for such request.

In another embodiment, the business user interface provides for composing and submitting responses to members of a group associated with a particular request for action, and further provides a system by which the response to the particular request is approved by a person having appropriate authority. After approval, the response is sent to members of a group associated with the particular request. The approval system is further applied in some embodiments, to any information which is posted for review in the client interface, including new requests for action, and new comments submitted by members of the groups.

In one embodiment, the data comprises a node-link structure, including nodes for requests for action arranged in a hierarchy, or request tree. The request tree contains nodes for categories as well as nodes for requests, and can be searched. The nodes for requests for action are further linked with nodes for groups, which are linked with nodes for members of groups which are further linked to nodes for responses submitted to groups. Other data models may be utilized for accomplishing these functions.

Other embodiments of the invention include a system which comprises a database for storing the data about groups of persons described above, and server which is coupled to a communication network that includes resources to provide the client interface for use of the data via the communication network, and resources to provide the business user interface for use of the data via the communication network.

Another embodiment of the invention comprises an article of manufacture including a machine readable data storage medium storing computer program instructions. The computer program instructions in this aspect of the invention upon execution establish a database for data about groups of persons associated with request for action, and resources to provide a client interface and a business user interface, as described above.

Thus, the present invention supports a method for communicating with groups of individuals that comprises:

maintaining data about groups of persons, wherein the groups of persons are associated with a request for action;

presenting a client interface to network, where the client interface includes an information model by which persons using the interface find and become members of one or more of the groups, which have been built around the common wants of the individuals as expressed by requests for action;

providing tools to persons in the network by which requests for action are approved for use in formation of a group;

sending a response to members of a particular group based upon the request for action associated with the particular group;

providing tools to accept communication from persons in the particular group which indicate replies to the responses; and

maintaining information about the responses sent to particular groups and replies to the responses.

Business users can choose which categories to track and receive notifications of important events for requests within those categories. The business users tracking the information are able to interact with the members of a group based upon comments submitted by the users, and replies to the responses submitted. Furthermore, statistics are maintained about the groups and the members of a group which provide insight which can be used for crafting responses.

According to the present invention, a real-time customer interaction platform is provided, based upon communication with groups who have come together around common requests for action. Clients view the data model, such as a request tree that includes categories and subcategories, and requests and sub-requests. Both business users and clients are able to use the request tree to browse and search for existing requests for the purposes of joining or interacting with a groups, and for the purposes of placing new requests around which new groups may form.

By providing tools that encourage clients to join groups, and that allow business users to readily monitor and analyze information about the groups and requests for action around which the groups have formed, more effective communication and client service is achieved. More important issues are highlighted by the activity of groups that are identified with such issues. Less important issues receive less traffic, and less customer interest in the system; so they can be dealt with using lower priorities. Overall, the present invention addresses the customer service problem and other problems involving understanding the wants of people, making them less intractable by processes using network based tools encouraging group behavior. A platform used to facilitate such processes is provided herein.

Other aspects and advantages of the present invention can be seen upon review of the figures, the detailed description and claims which follow.

### BRIEF DESCRIPTION OF THE FIGURES

FIG. 1 is a simplified diagram of the computer network supporting the platform of the present invention.

FIG. 2 is a simplified block diagram of a server providing the group program operations of the present invention.

FIG. 3 is a flow chart illustrating a life cycle of a request according to one embodiment of the invention.

FIG. 4 is a flow chart of client interaction with a client interface according to one embodiment of the present invention.

FIG. 5 is a flow chart of a business user interaction with a business interface according to one embodiment of the present invention.

FIGS. 6A, 6B, and 6C together show a data model for a database storing information about groups of persons associated with respective requests for action according to one embodiment of the present invention.

FIG. 7 illustrates an opening page of a client interface with a top level of a request directory according to one embodiment of present invention.

FIG. 8 illustrates a page of a client interface with a intermediate level of the request directory according to one embodiment of the present invention.

FIG. 9 illustrates a page of a client interface identifying requests for action available in the data model according to one embodiment of the present invention.

FIG. 10 illustrates a view of a request, with tools for joining or commenting on the request in a client interface according to one embodiment of the present invention.

FIG. 11 illustrates a view of a tool used for creating a new request in a client interface in one embodiment of the present invention.

FIG. 12 illustrates a screen used for signing in new users of the platform in a client interface in one embodiment of the present invention.

FIG. 13 shows a top-level web page in a business user interface according to one embodiment of the present invention.

FIG. 14 illustrates an intermediate level web page in the business interface according to one embodiment of the present invention.

FIG. 15 illustrates a page used for analysis of requests in a business user interface in one embodiment of the present invention.

FIG. 16 illustrates a page used for reviewing comments about a particular request for action in a business user interface in one embodiment of the present invention.

FIG. 17 illustrates a page in a business user interface showing information about a group associated with a particular request for action used for analysis.

FIG. 18 illustrates a page used for a first step in designing a response in a business user interface in one embodiment of the present invention.

FIG. 19 illustrates a page used for a second step in designing a response in a business user interface in one embodiment of the present invention.

FIG. 20 illustrates a page used for a third step in designing a response in a business user interface in one embodiment of the present invention.

FIG. 21 illustrates a page used for a fourth step in designing a response in a business user interface in one embodiment of the present invention.

FIG. 22 illustrates a page used for a fifth step in designing a response in a business user interface in one embodiment of present invention.

FIG. 23 illustrates a page in a business user interface showing requests pending approval in one embodiment of the present invention.

FIG. 24 illustrates a page showing a communication template in a business user interface in one embodiment of the present invention.

FIG. 25 illustrates a page showing an offer template in a business user interface in one embodiment of the present invention.

FIG. 26 illustrates a page including a tool for editing a category in the request tree in one embodiment of the present invention.

FIG. 27 illustrates a tool in a business user interface for adding a new request to the data model in one embodiment of present invention.

FIG. 28 illustrates a page including a tool for approving requests in a business user interface in one embodiment of the present invention.

FIG. 29 illustrates a page used for analysis of requests in a business user interface in one embodiment of the present invention.

FIG. 30 illustrates a page of a business web site, from which a client may enter the client interface of the present invention in context.

FIG. 31 illustrates an entry page of the client interface displayed upon entry by the client from the page of FIG. 30.

### DETAILED DESCRIPTION

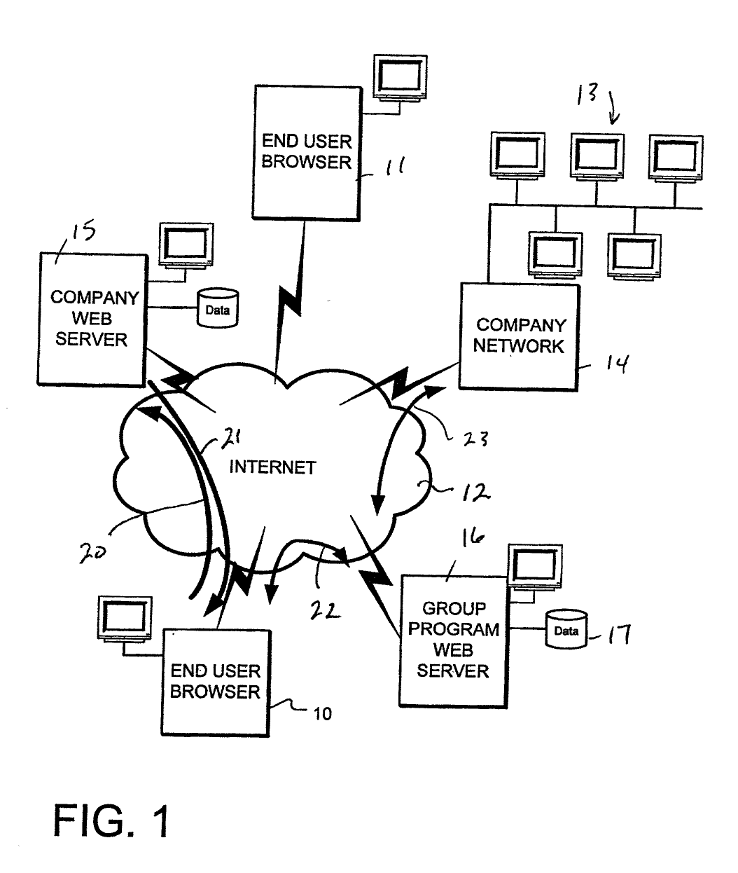

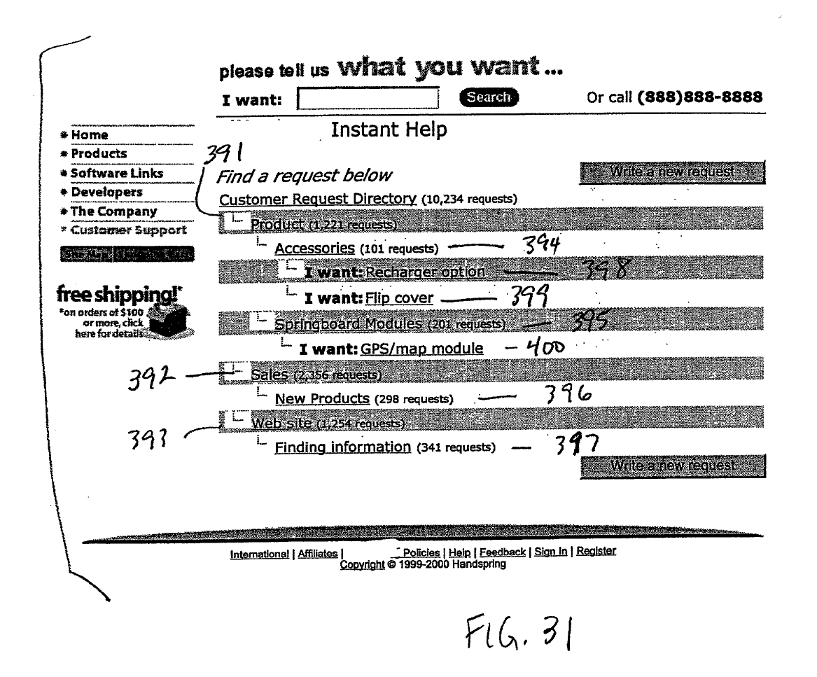

A detailed description of preferred embodiments of the present invention is provided with respect to FIGS. 1 through 31, in which FIGS. 1 through 5 provide an overview of the platform, FIGS. 6A-6C illustrate a data model used in one embodiment, and FIGS. 7 through 29 illustrate example Web pages used in a client interface and in a business user interface. FIGS. 30 and 31 illustrate the process of entering the client interface in context.

FIG. 1 illustrates a network view of the platform. In this example, clients have end-user browsers 10 and 11 which are coupled to the Internet 12. A business has a company network 13 by which a plurality of business users access the Internet through a server 14. The company in this embodiment also operates a web server 15 presenting content to the clients, such as catalogs or other information about the goods and services of the business. In this embodiment of the present invention, a group program web server 16 is included. The group program web server maintains data 17 about groups of individuals who are associated with particular requests for action, and provides a business user interface and a client interface facilitating access to such data and use of such data for improving the communications between the business and the clients. Thus for example, a client operating browser 10 may access the company web server as indicated by arrow 20. A page presented by the web server 15 includes a link to the group program server 16. This link is provided back to the client as indicated by arrow 21, if selected. The client uses the link to access and interact with the group program server 16 as indicated by arrow 22. The client interacts with the group program web server 16 using the processes of the present invention which facilitate real-time interaction on a group basis with representatives of the business. Business users on network 13 access the group program web server 16 as indicated by arrow 23, and interact with the data stored there and the clients who are registered with particular groups.

The systems shown in FIG. 1 can be implemented using a wide variety of technologies available in the art for establishing communication using the Internet, or other communication networks. According to the present invention, the group program web server 16 provides a platform which manages data 17 about groups of individuals who are associated with respective requests for action, presents a client interface by which clients may browse and select appropriate requests for action, and presents a business interface by which business users in the network 13 may monitor activity of the groups, communicate with the groups, and otherwise improve interaction between the business and groups of individuals based upon their wants.

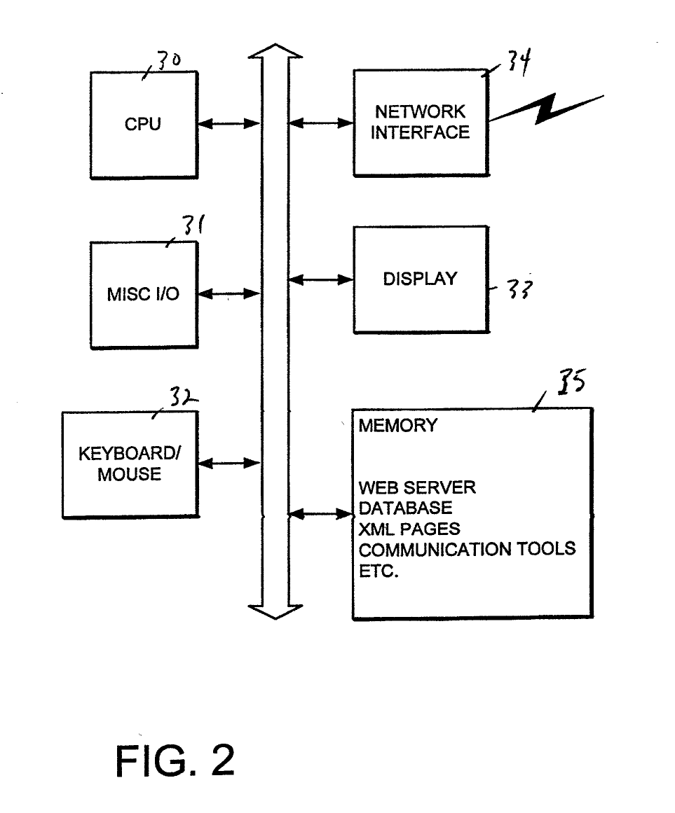

FIG. 2 provides a simplified diagram of a group program Web server which provides the platform of present invention. The server includes a central processing unit 30, miscellaneous input/output devices 31, user input tools 32 such as a keyboard and mouse, a display 33, a network interface 34, and memory 35. The memory 35 includes computer program instructions in machine readable format which support the platform. Such instructions include Web server software, database software, communication tools, a repository of web pages, such as pages implemented using a standard markup language like HTML or XML, used as the business interface and as the client interface, and other supporting programs known in the art.

The block diagram of FIG. 2 is representative of a wide variety of computer systems suitable for use as servers, including systems manufactured by Sun Microsystems, systems running Microsoft Windows-based operating systems, and other data processing architectures. Furthermore, the server may include a plurality of CPUs, or a plurality of computer systems, interconnected for inter-operation using technologies known in the art.

The memory 35 in this example can be implemented using a wide variety of memory architectures, such as disk drives, random access memory, or other data storage media. One embodiment of the present invention comprises a data storage medium storing the computer program instructions which are readable and executable by a system such that represent by FIG. 2.

In one embodiment, components of FIG. 1 and FIG. 2 are used to manage groups of persons associated with requests for action. Requests for action therefore have a typical “life cycle” in the system which involves a process of interaction such as the following. The steps in the representative process of interaction include:

1. End user creates a new request. (Business users can also create requests but this is not the common case.)

2. A customer service representative (CSR) approves the request (editing it if necessary) and creates a response. The response is sent in email to the original end user.

3. If the CSR decides to publish the request, it is now up on the site and other end users can ask for it too. Each new end user receives an instant response on the site. The system collects data such as satisfaction level so that it can monitor the effectiveness of the response.

4. If the request becomes popular and/or the response is not effective, then the system will notify one or more business analysts. The business analyst can be anyone from the CEO to a product manager to a customer service analyst. Business analysts are notified of critical requests if they are tracking the category or if they browse into the “critical issues” list for the category. Business analysts can also find requests that seem problematic by browsing around.

5. Once a business analyst identifies a request as problematic, he or she can track the request to keep up to date on what's happening, view graphs and read comments and response-reactions from end users to understand the issue, and decide how to resolve the problem. Ultimately, this leads to a new response for the request (probably written by a CSR at the direction of a business analyst).

6. Existing members of the request group receive the new response in email, and the process returns to step 3. If the request remains critical, it will reach step 4 a second time, perhaps with a different business analyst.

Sub-requests, or “more specific requests,” are requests whose parents in the request tree are other requests, rather than categories. Sub-requests let people make their criteria clear within a broader issue. They also help the business increase economies of scale when responding to requests, because the business can choose to use the parent's response for sub-requests that don't warrant separate treatment. (The business can decide to do this when approving a new sub-request, when moving a request within another request, or when writing a new response for a request with sub-requests.)

Because the business may choose to use the same response for several requests, and a consumer may select a request along with sub-requests for a specific problem, there is a many-to-many relationship between requests and responses. Elements in FIGS. 6A-6C which relate to this aspect include the RESPONSE_FOR_GROUP entity mediates the many-to-many relationship between request groups and responses. The RESPONSE_FOR_USER entity records a user's interaction with a response; the RESPONSE_FOR_MEMBER entity records that a user received a response because of membership in a specific group.

When a business creates a separate response for a sub-request, it may create a more specific apology (in the COMMUNICATION component shown in the figures) but make the same offer. If a user requests both the parent and the sub-request, the system must present both responses but may wish to present the offer only once or label it as a duplicate. In one embodiment, the OFFER.OFFER_ACCEPT_MAX field shown in the figures records how often a user can accept an offer (where the offer may be present in multiple responses) before the system labels the offers as having already been accepted elsewhere.

For requests for action, as opposed to requests for information, the business can include an offer in the response. When the consumer receives the response, he or she can accept or reject. If the consumer accepts the offer, he or she is forwarded to a web page that can initiate a transaction, or provided other tools for completing the offered transaction.

Although satisfaction with a response is recorded at the time a response is received, post-redemption satisfaction surveys may also be used.

For reporting purposes the system classifies offers as either incentives and solutions. For example, if someone complains about dropped calls on a cell phone and the business offers them free air time, that is an incentive. If the business promises to install a new transmitter near that location, that is a solution. A company may use a small set of incentives and run financial analyses to determine how cost-effective each incentive is in retaining customers.

A group member's attitude, with respect to a request for action itself, maybe “agree” or “oppose.” (This is stored in MEMBER.ATTITUDE as shown in the figues). For example, a group member may “oppose” a request to add features to a product, on the grounds that the feature is not useful to him or her. This can be important in situations where the business is trying to aggregate customer feedback or sell a tailored product or service to a group. For example, if someone asks for an extra feature and several people oppose it, the business knows that adding the feature to the tailored service might reduce sales.

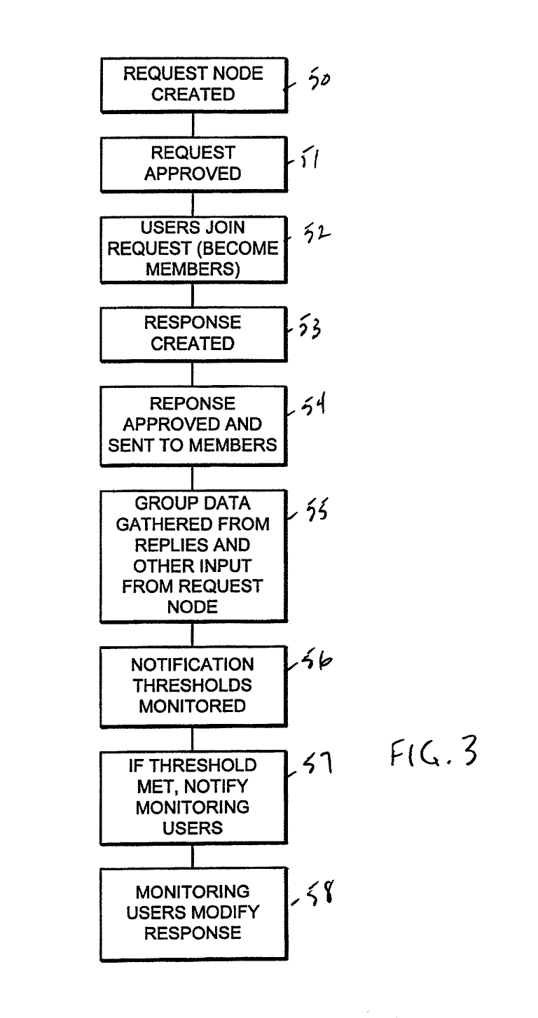

FIG. 3 is a flow chart illustrating a request life cycle from an alternative point of view. In the first step, a request node in a request hierarchy database is created (step 50). The request node is created by a client or a business user by entering request text using a tool provided in the client or business user interfaces. Next, the request is approved by a business user having appropriate authority (step 51). Approved requests are posted in the client interface (and in the business user interface) allowing users to join in the request, and thereby become members of the group associated with the request (step 52). As the group grows (or upon first reviewing the request as suggested above), a business user creates a response to the request using a tool provided a business user interface (step 53). The response is approved by a business user having appropriate authority, and then sent to members of the group associated with the request for action that the response is directed to resolve (step 54). The response will include tools, such as a hyperlink or email prompt, allowing clients to reply to the responses, indicating acceptance, rejection or other parameters such as levels of satisfaction with the response. Group data is gathered from replies to the responses, and other inputs from a request node, such as comments that may be entered using a tool provided in a client interface (step 55). The platform monitors the group activity and statistics associated with a group (step 56) and notifies business users who are tracking the request group, and categories above the request group in the tree, when thresholds are met, including thresholds relating to characteristics being achieved like when a group being monitored becomes one of the largest groups, one of the fastest growing groups of one characterized by a metric suggesting high levels of dissatisfaction (step 57). Business users receiving the notifications are able to use tools provided in the business user interface to modify the response, to prepare the responses, or to do other activities supporting interaction with the group of persons associated with the particular request for action (step 58).

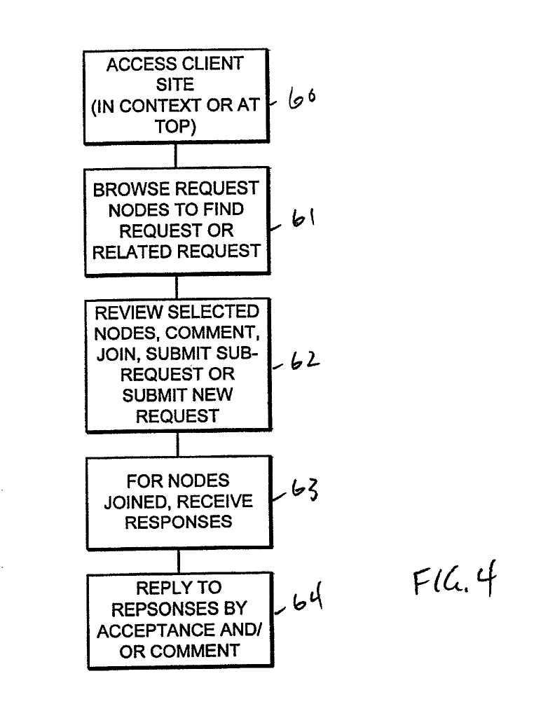

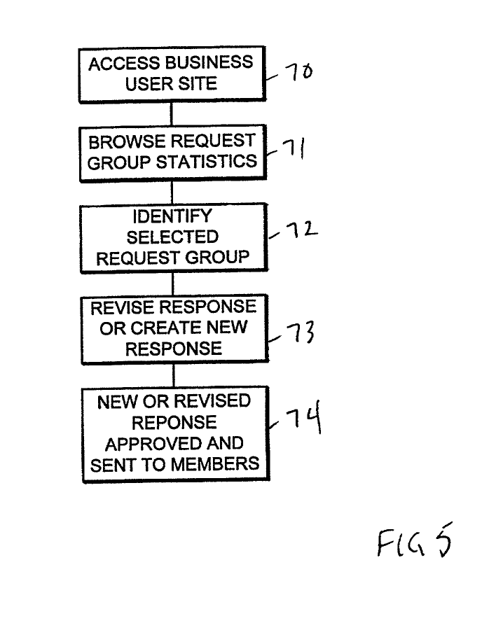

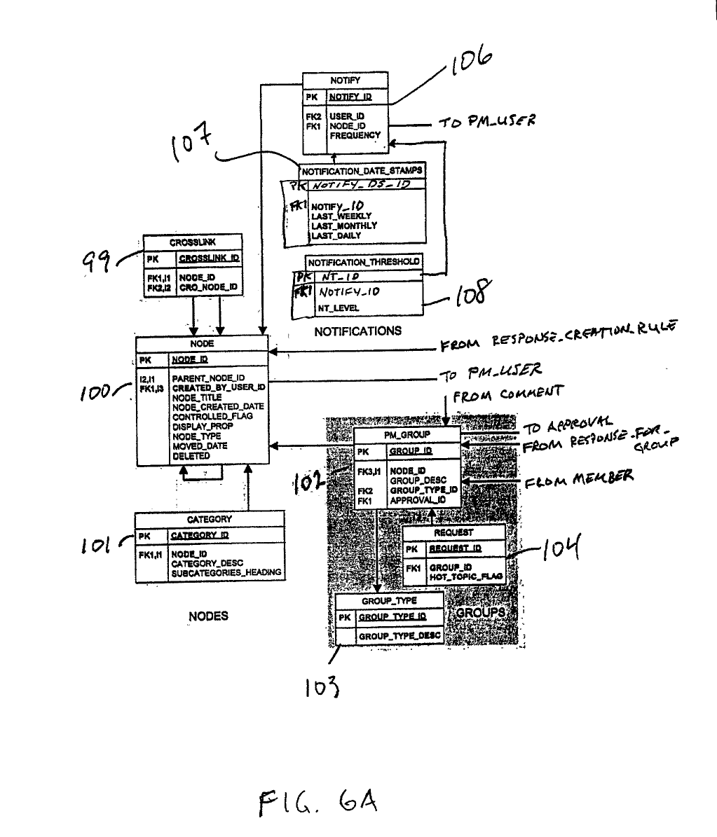

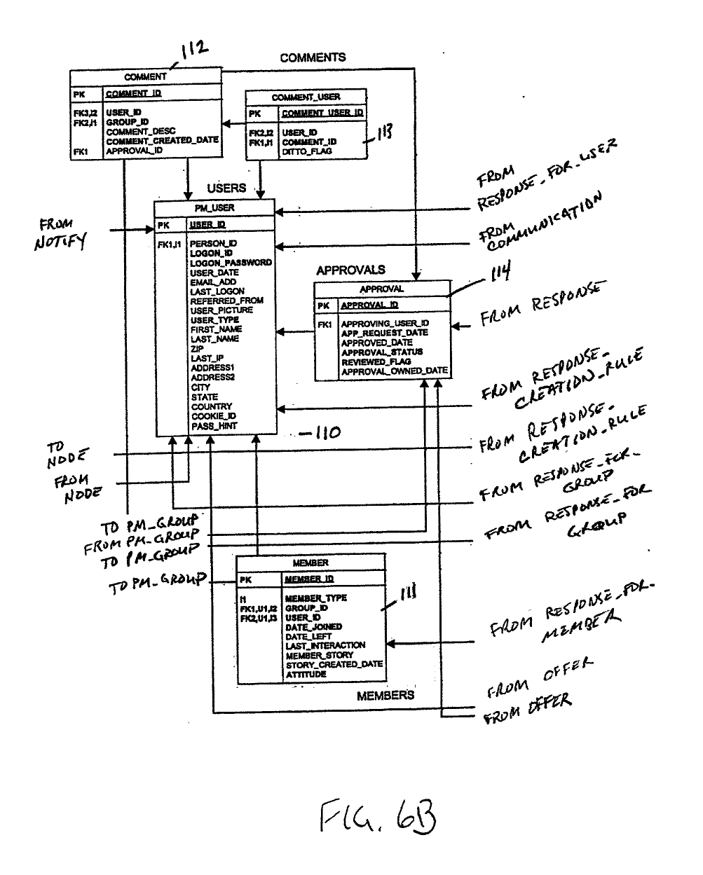

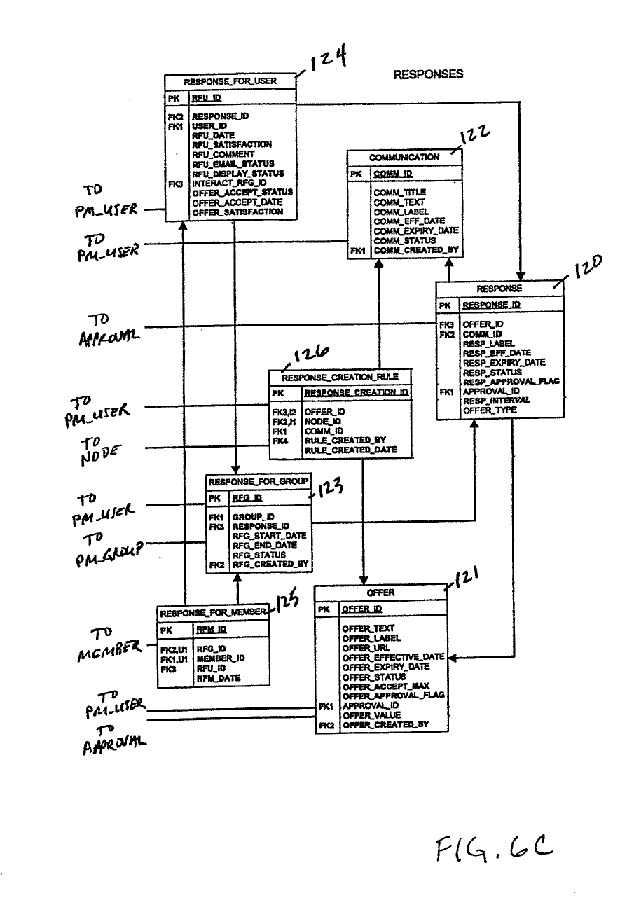

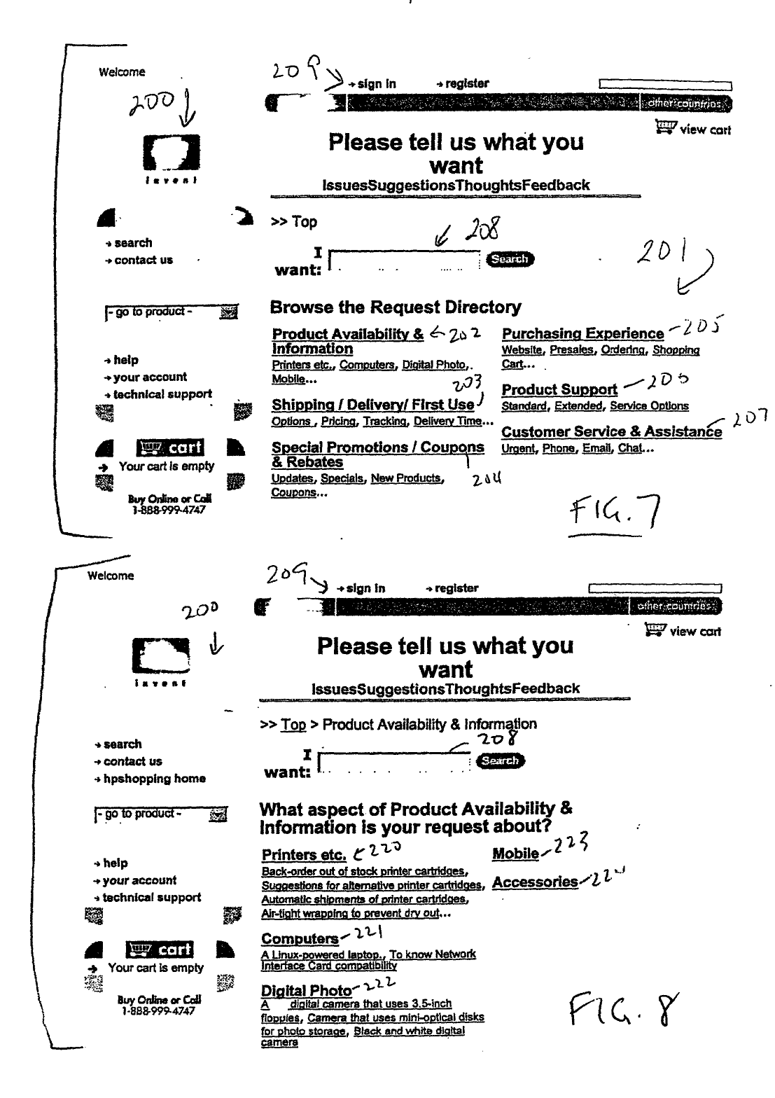

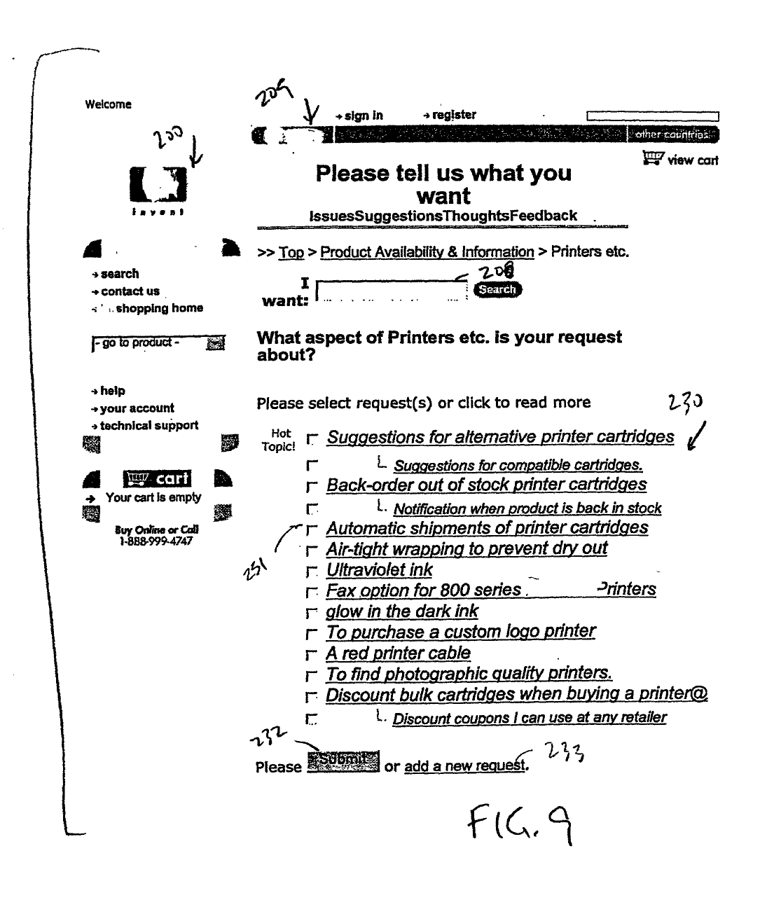

FIG. 4 is a flow chart of interaction from a client point of view. This process begins with a client accessing a client site (step 60). The client is presented with a request tree, or other data model, and may be placed in the tree at a location which is relevant to the context from which the client entered the site, or simply at a location at the top of the tree. In one embodiment, the client is presented a list of likely locations, including categories and common requests, in the tree at which to start browsing based upon context. The client browses request nodes in the data model to find a request for action which addresses the client's want, or to find related requests (step 61). Selected nodes are reviewed by the client, and using the client interface, the client may comment on the request, join in the request, submit a sub-request, or submit a new request (step 62). Clients can join multiple groups simultaneously, and the system figures out which responses go with those requests, and shows the list of responses. If the same response goes with more than one request, that response is shown only once, in one embodiment.

For request nodes which the client joins, the client will receive responses which have been prepared for the group associated with that request node (step 63). The responses are provided to the client in various modes, such as while browsing the request node, after the client signals that he or she is joining in the request, or after the company creates a response to the request. The client is able to reply to the responses by acceptance, rejection, comments, or other mode of interaction provided by the client interface (step 64). Example modes by which the client receives the responses include, but are not limited to, electronic mail channels and communication provided in the client interface directly. The particular modes for communication with clients depend on the needs of the particular implementation, and the type of response provided.

FIG. 5 is a flow chart of interaction from a business user point of view. This process begins with a business user accessing the business user site (step 70). The business user browses request group statistics and other information which is generated by the platform intended to characterize the activity of the group of individuals associated with particular requests for action (step 71). The business user, based upon analysis of the information presented in the business user interface like notifications about groups meeting preset thresholds of activity, identifies a selected request group (step 72). The business user then revises the responses which had been provided, creates new responses, or performs other activities intended to improve the quality of interaction with the group on behalf of the business (step 73). Finally, new or revised responses are approved by persons having appropriate authority, and sent to members of the group (step 74). Ideally, the cycle continues until the needs of the group are well understood and, hopefully, satisfied.

FIGS. 6A, 6B and 6C illustrate one preferred data model for implementing the platform of the present invention. The data model comprises a node-link structure implemented using a relational database, which comprises a plurality of tables, having entries as described below. The labels used include: “PK” which identifies the primary key of the table; “FKn” (where “n” in an integer) identifies a foreign key (pointing to a row, usually a primary key, in another table); “In” (where “n” in an integer) identifies an index in the table, and “Un” (where “n” in an integer) identifies an unique index in the table. In FIGS. 6A-6C, arrows between tables represent foreign keys which link the tables to each other.

The database establishes a node-link structure by which groups formed around requests for action are organized for browsing by clients and business users. The node-link structure includes a NODE table 100. The NODE table 100 provides a node identifier, a parent node identifier, and an indication of the user responsible for creation of the node. Other information about the node is included, such as the date, a control level for the node (i.e. are requests allowed within the node), display properties, when the NODE has been moved in the structure or deleted from the structure. NODE tables at the top of the tree have a parent node ID which is the same as their own node ID. In addition to links between parent and child NODE tables, the structure includes a CROSSLINK table 99 by which NODE tables 100 are interconnected within the node-link structure.

In this example, there are three types of nodes, including a CROSSLINK type node, a CATEGORY type node and a GROUP type node. A corresponding CATEGORY table 101 is linked to the NODE table 100 for CATEGORY type nodes. A corresponding PM_GROUP table 102 is linked to the NODE table 100 for GROUP type nodes.

Other tables associated with the PM_GROUP table 102 include a GROUP_TYPE table 103 and a REQUEST table 104. Thus, groups are associated with requests for action that are organized within the node-link structure as group type nodes.

In FIG. 6A, other tables include a set of tables related notifications including a NOTIFY table 106 and related NOTIFICATION_DATE_STAMPS table 107 and NOTIFICATION_THRESHOLD table 108. The tables related to notifications are used for communications with users, such as business users upon events related to notification thresholds or other instances in which information about the group is to be distributed to users.

The tables and fields in the tables for FIG. 6A include the following: (Comments next to names, along with the names, of the parameters explain use of parameter.)

| NODE table 100: | | a node in the request tree |
|---|---|---|
| | PK | NODE_ID - the unique identifier for this node |
| | I2,I1 | PARENT_NODE_ID - This node's parent (=NODE_ID if this is the root |
| | | of the tree) |
| | FK1,I3 | CREATED_BY_USER_ID - who created this node |
| | | NODE_TITLE - the short description shown while browsing |
| | | NODE_CREATED_DATE |
| | | CONTROLLED_FLAG - whether or not requests should be added to this |
| | | node (usually off for the top 1- 3 levels of categories in the tree). |
| | | DISPLAY_PROP - for categories, controls where it is shown within its |
| | | parent. |
| | | NODE_TYPE - whether node is a category, group or cross-link |
| | | MOVED_DATE - the last date at which the node was moved (meaning |
| | | PARENT_NODE_ID was changed) |
| | | DELETED - if yes, the node is hidden on most screens |

CROSSLINK table 99: - a cross-link in the request tree

| | |
|---|---|
| PK | CROSSLINK_ID - |
| FK1,I1 | NODE_ID - the node this cross-link corresponds to |
| FK2,I2 | CRO_NODE_ID - the node this cross-link points at (which node the user |
| | should see when he or she clicks on the cross-link) |

CATEGORY table 101: a category in the request tree

| | |
|---|---|
| PK | CATEGORY_ID - the unique identifier for this category |
| FK1,I1 | NODE_ID - the node this category corresponds to |
| | CATEGORY_DESC - the long text describing this category |
| | SUBCATEGORIES_HEADING - what to show above the left and right |
| | columns of subcategories (if any) |

PM_GROUP table 102: - a group

| | |
|---|---|
| PK | GROUP_ID - the unique identifier for this node |
| FK3,I1 | NODE_ID - the node this group corresponds to |
| | GROUP_DESC - the long text describing this group |
| FK2 | GROUP_TYPE_ID - the type of this group |
| FK1 | APPROVAL_ID - the approval object for this group |

GROUP_TYPE table 103: records the valid values of GROUP_TYPE_ID

| | |
|---|---|
| PK | GROUP_TYPE_ID - |
| FK1 | GROUP_TYPE_DESC - |

REQUEST table 104: a request

| | |
|---|---|
| PK | REQUEST_ID - the unique identifier for this request |
| FK1 | GROUP_ID - the group this request corresponds to |
| | HOT_TOPIC_FLAG - if this request should be shown ahead of other |
| | requests in the same category |

NOTIFY table 106: records a user's desire to receive news about a node

| | |
|---|---|
| PK | NOTIFY_ID - the unique identifier |
| FK2 | USER_ID - the user |
| FK1 | NODE_ID - the node |
| | FREQUENCY - how often to send email |

NOTIFICATION_DATE_STAMPS table 107: keeps track of which notifications have been sent

| | |
|---|---|
| PK | NOTIFY_DS_ID - the unique identifier for this table |
| FK1 | NOTIFY_ID |
| | LAST_WEEKLY - records the last time weekly news was sent |
| | LAST_MONTHLY - records the last time monthly news was sent |
| | LAST_DAILY - records the last time daily news was sent |

NOTIFICATION_THRESHOLD table 108:

| | |
|---|---|
| PK | NT_ID |
| FK1 | NOTIFY_ID |
| | NT_LEVEL |

FIG. 6B shows additional tables in the database. The additional tables shown in FIG. 6B include a PM_USER table 110, a MEMBER table 111, a COMMENT table 112, a COMMENT_USER table 113 and an APPROVAL table 114. The PM_USER table 110 is used for information about users of the system, including clients of the service who are further identified in the MEMBER table 111, and business users. Most of the tables in the database include a foreign key identifying a particular user responsible for creation or management of the item. The MEMBER table 111 maintains information about members of groups and is linked to the corresponding PM_GROUP table 102. The COMMENT table 112 is used to track comments provided by users related to particular groups. The COMMENT_USER table 113 allows users to agree with or join in comments that are reflected in the COMMENT table 112. The APPROVAL in table 114 is used for maintaining information about approval of groups formed around requests for action, approval of comments, approval of responses in some cases, and approval of offers. The tables shown in FIG. 6B and the fields within the tables include the following:

PM_USER table 110: stores both clients and employees

| | |
|---|---|
| PK | USER_ID - the unique identifier for this table |
| FK1,I1 | PERSON_ID |
| | LOGON_ID |
| | LOGON_PASSWORD |
| | USER_DATE |
| | EMAIL_ADD |
| | LAST_LOGON |
| | REFERRED_FROM |
| | USER_PICTURE |
| | USER_TYPE |
| | FIRST_NAME |
| | LAST_NAME |
| | ZIP |
| | LAST_IP |
| | ADDRESS1 |
| | ADDRESS2 |
| | CITY |
| | STATE |
| | COUNTRY |
| | COOKIE_ID |
| | PASS_HINT |

MEMBER table 111: records a user's membership in a group

| | |
|---|---|
| PK | MEMBER_ID - the unique identifier for this table |
| I1 | MEMBER_TYPE |
| FK1,U1,I2 | GROUP_ID - the group the user belongs to |
| FK2,U1,I3 | USER_ID - the user who belongs to the group |
| | DATE_JOINED - date the member joined the group |
| | DATE_LEFT - date the member left the group (if any) |
| | LAST_INTERACTION - the last date the member participated in the |
| | group |
| | MEMBER_STORY - the member's description of the situation that |
| | prompted them to join |
| | STORY_CREATED_DATE - the date the story was created |
| | ATTITUDE - agree or opposed |

COMMENT table 112: records a user's comment on a group

| | |
|---|---|
| PK | COMMENT_ID - the unique identifier for this table |
| FK3,I2 | USER_ID - the user who wrote this comment |
| FK2,I1 | GROUP_ID - the group this comment is about |
| | COMMENT_DESC - the text of the comment |
| | COMMENT_CREATED_DATE - the date the comment was created |
| FK1 | APPROVAL_ID - the approval object for this comment |

COMMENT_USER table 113: records a user's “ditto” (agreement with a comment)

| | |
|---|---|
| PK | COMMENT_USER_ID - the unique id |
| FK2,I2 | USER_ID - the user who dittoed |
| FK1,I1 | COMMENT_ID - the dittoed comment |
| | DITTO_FLAG - unused |

APPROVAL table 114: records the approval status of an object

| | |
|---|---|
| PK | APPROVAL_ID - the unique id |
| FK1 | APPROVING_USER_ID - the user who reviewed the object (if anyone) |
| | APP_REQUEST_DATE - the date approval was requested |
| | APPROVED_DATE - the date the object's disposition was determined |
| | APPROVAL_STATUS - the object's disposition |
| | REVIEWED_FLAG - whether the object has been reviewed yet |
| | APPROVAL_OWNED_DATE - when the APPROVING_USER started |
| | looking at this object (both may be set before the object is actually |
| | approved) |

FIG. 6C shows tables related to responses that are prepared by business users and submitted to members of groups. A RESPONSE table 120 maintains status of responses including date and approval status. Other information about the responses is included in the RESPONSE table 120, such as communications associated with a response, and offers associated with a response. Related tables include a COMMUNICATION table 122 and an OFFER table 121. Responses include at least a communication, and optionally an offer. The offer table 121 includes a foreign key linking the OFFER table 121 to the APPROVAL table 114. A RESPONSE_CREATION_RULE table 126 is used for management of the creation of communications and offers. Thus, the system provides templates and other techniques for managing response creation. The database provides an RESPONSE_FOR_GROUP table 123 and an RESPONSE_FOR_USER table 124 for managing to the communication of responses to users. An approved response is linked to a RESPONSE_FOR_GROUP table 123. This table is in turn linked to the groups formed around requests for action which the response is intended to address. The RESPONSE_FOR_USER table 124 is linked to responses. The RESPONSE_FOR_USER table 124 carries status and information about acceptance, rejection, levels satisfaction, or other information relating to replies to responses. A RESPONSE_FOR_MEMBER table 125 is included for linking responses characterized by the RESPONSE_FOR_GROUP table 123 to individual members of a group. The tables and fields in the tables shown in FIG. 6C include the following:

RESPONSE table 120: a response

| | |
|---|---|
| PK | RESPONSE_ID - the unique id |
| FK3 | OFFER_ID - the offer used for this response (if any) |
| FK2 | COMM_ID - the communication used for this response |
| | RESP_LABEL |
| | RESP_EFF_DATE |
| | RESP_EXPIRY_DATE - how long it takes for the response to expire |
| | after someone receives it |
| | RESP_STATUS |
| | RESP_APPROVAL_FLAG |
| FK1 | APPROVAL_ID - the approval object for this response |
| | RESP_INTERVAL |
| | OFFER_TYPE - whether this is an incentive or a solution |

OFFER table 121: an offer

| | |
|---|---|
| PK | OFFER_ID - the unique id |
| | OFFER_TEXT - the text of the offer |
| | OFFER_LABEL - a label used to describe the offer succinctly within the |
| | business |
| | OFFER_URL - the transactional page to forward the user to upon accept |
| | OFFER_EFFECTIVE_DATE |
| | OFFER_EXPIRY_DATE |
| | OFFER_STATUS |
| | OFFER_ACCEPT_MAX - how often any given user can accept the offer, |
| | or 0 for unlimited |
| | OFFER_APPROVAL_FLAG |
| FK1 | APPROVAL_ID - the approval object for this offer |
| | OFFER_VALUE |
| FK2 | OFFER_CREATED_BY - the user who created the offer |

COMMUNICATION table 122: a communication

| | |
|---|---|
| PK | COMM_ID - the unique id |
| | COMM_TITLE - the title of the communication |
| | COMM_TEXT - the text of the communication |
| | COMM_LABEL - a label used to describe the offer succinctly within the |
| | business |
| | COMM_EFF_DATE |
| | COMM_EXPIRY_DATE |
| | COMM_STATUS |
| FK1 | COMM_CREATED_BY - the user who created the communication |

RESPONSE_FOR_GROUP table 123: records that a response was made to a group

| | |
|---|---|
| PK | RFG_ID - the unique id |
| FK1 | GROUP_ID - the group the response was made to |
| FK3 | RESPONSE_ID - the response made to the group |
| | RFG_START_DATE - when the response became available |
| | RFG_END_DATE - when the response was turned off |
| | RFG_STATUS |
| FK2 | RFG_CREATED_BY - who created this object |

RESPONSE_FOR_USER table 124: records that a response was given to a user

| | |
|---|---|
| PK | RFU_ID - the unique id |
| FK2 | RESPONSE_ID - the response the user received |
| FK1 | USER_ID - the user who received the response |
| | RFU_DATE - the date the response was received |
| | RFU_SATISFACTION - the user's satisfaction with this response (if |
| | specified) |
| | RFU_COMMENT - the text of the user's reaction to this response (if any) |
| | RFU_EMAIL_STATUS - whether the response needs to be or has been |
| | sent in email, and whether the email was triggered by the group |
| | being reviewed or moved. |
| | RFU_DISPLAY_STATUS - whether the user has seen the response on |
| | the web site. |
| FK3 | INTERACT_RFG_ID - the RESPONSE_FOR_GROUP that caused the |
| | user's last interaction with this response |
| | OFFER_ACCEPT_STATUS - whether the user has accepted the offer or |
| | not |
| | OFFER_ACCEPT_DATE - the date the user accepted the offer |
| | OFFER_SATISFACTION - is unused |

RESPONSE_FOR_MEMBER table 125: records that a response was provided to a user in the

| context of that user being a member of a group | |
|---|---|
| PK | RFM_ID - the unique identifier for this group |
| FK2,U1 | RFG_ID - the RESPONSE_FOR_GROUP that caused this object to be |
| | created |
| FK1,U1 | MEMBER_ID - the member of the group that was given the response |
| FK3 | RFU_ID - the RESPONSE_FOR_USER object that this |
| | RESPONSE_FOR_MEMBER corresponds to |
| | RFM_DATE - the date this object was created |

RESPONSE_CREATION_RULE table 126: records that an offer or communication should be

| used as a template within some portion of the tree | |
|---|---|
| PK | RESPONSE_CREATION_ID - the unique id |
| FK3,I2 | OFFER_ID - the offer that should be used |
| FK2,I1 | NODE_ID - a node beneath which this template should be used |
| FK1 | COMM_ID - the communication that should be used |
| FK4 | RULE_CREATED_BY - the user that created this rule |
| | RULE_CREATED_DATE - when the rule was created |

Additional tables not shown in FIGS. 6A-6C are used in alternative embodiments, including NODE_TREE, HISTORY_RESPONSE_FOR_USER, RPT_GRP_MBRS, RPT_GRP_SAT, RPT_GRP_ACPT.

NODE_TREE allows a single, very fast and simple query to return a list of all nodes above or below a given node. Each record links a node to one of its “ancestors” above it in the node hierarchy and stores the number of “generations” separating the two nodes. All data is derived from the NODE table and can be re-computed from it. The fields in NODE_TREE include:

NODE_ID: Identifies node.

HIGHER_NODE_ID: Identifies “ancestor” node.

LEVELS: Number of “generations” separating the nodes.

HISTORY_RESPONSE_FOR_USER: Stores a history of all versions of every record in the RESPONSE_FOR USER table. Has exactly the same fields as RESPONSE_FOR USER table, with the addition of the INSERT_DATE field, which stores the date and time that the referenced version of the RESPONSE_FOR_USER record was updated/inserted.

RPT_GRP_MBRS: Stores derived data about the number of members of each group and how this number changes on a daily basis. It also stores daily, derived data about the number of business users tracking each group, the group's active response, if any, and the active offer, if any.

RPT_GRP_SAT: Stores derived data about the satisfaction levels expressed by members of each group, including counts at each satisfaction level and the average (mean) satisfaction level of members in each group, and how these satisfaction levels change on a daily basis.

RPT_GRP_ACPT: Stores derived data about the interactions of members in each group with offers for that group, including the counts of each interaction type (“accept,” “reject,” “decide later,” etc.), and how the interactions change on a daily basis.

The system supports several alternative ways of determining what to offer someone, based upon history of interaction between the client (end user) and the business. For examples, consider the following:

1. A response could contain multiple offers instead of just one. (An end user would accept or reject the entire package.)

2. If the response is X and the company makes a new response Y, here are some alternatives in terms of who gets what, where the name of the rule for handling a new response “Y” is in the first column, the response sent in the event the user accepted the first response “X” is in the second column, the response sent if the user rejected the first response is in the third column, the response sent if the user is undecided about the first response is in the fourth column, and the response sent if the user is a new user, and did not receive the first response, is in the fifth column:

| | ACCEPTED | REJECTED | UNDECIDED | |
|---|---|---|---|---|
| RULE | X | X | X | NEW |
| supercedes | X | Y | Y, not X | Y |
| alternative | X | Y | X xor Y | X xor Y |
| subsequent | X | Y | X then Y | Y |
| | | | if reject | |
| lesser | X | Y (on site) | Y, not X | Y |
| cookie | X+Z | nothing | X | X |
| escalation | X | Y | X then Y | X then Y |
| | | | if reject | |
| replacement | X+Y | Y | X+Y | Y |

3. Constraints of the form “you can only get offer X twice.” In simplified versions of this—end users can only get some offers once, and if an end user goes over some dollar threshold, the end user gets escalated to a CSR instead of showing the offer(s).

4. Specify that response only applies to some class of members, by attitude (I want this, I'm neutral, I'm opposed to this) or by response status (accepted and satisfied, rejected or dissatisfied, undecided, and future).

Context-relevant request lists for end users are provided in some embodiments of the invention. For one example, see FIGS. 30 and 31 and the description of such figures below. Depending on what an end user was doing when he or she began enters the client interface, the system can present a special list of likely requests and categories. For example, if the user was trying to order a printer and received an out of stock message on the order confirmation page, the system can show requests related to that printer, out of stock items, and the order confirmation page. This way the end user can specify their request more conveniently. The system can also use the data collected about context and resulting requests to tell web operations staff what the top requests originating from a given context are.

In one example, the system encodes the context the end user was in—what page on the company's site the end user was using when he or she decided to make a request, and what the situation was. This can be encoded as name/value pairs, including standard variables such as page type (was the end user ordering an item, or checking order status?) and error code (had the end user just received an “out of stock” message?). This context is encoded in the URLs or http requests that end users use to navigate into the client interface service.

Given a representation of context for each end user in the system, the system tracks the correspondence between context and what request(s) the end users select. This creates a table with records like this:

Name=page

Value=order_confirm.jsp

Request=I want to know when my order will arrive

Number of members who selected request coming from the order confirm page=89

Total number of end users who came from the order confirm page=1431

Given historical data for context and request selection, the system computes predictions for a given context by finding requests that are frequently selected by end users with matching contexts. Likely categories can be predicted for example by aggregating the data across the requests in that category, and removing categories that are only likely because of a single request. In detail, an example process would be:

For each request R, we compute PR, the observed probability of selecting R, as follows:

PR=Sum over parameters in context of (Number of members who selected R with name=value)/Sum over parameters in context of (Number of end users with name=value)

For each category C, we compute PC, the observed probability of selecting a request in C:

PC=Sum over requests R in the category of (PR)

The most likely requests, which the system will show the user, are the top 5 or so requests sorted by PR, with only those where X is bigger than a threshold like 1% are shown.

The most likely categories are the top 5 or so categories sorted by Residual(PC), which is computed for the lowest-level categories first and builds up:

Residual(PC)=PC−(Sum over requests in the list which are within C of (PR))−−(Sum over subcategories C′ of Residual(PC′))

As an additional constraint on the category list, only show those where:

Residual (PC)>min over R shown of (PR)

The computation is optimized in some embodiments, and the output improved by removing from consideration records in the context-request table that did not meet some threshold of statistical significance or where PR was below a threshold. The system might also optimize the residual computation by keeping separate records of category selection by context. The quality of the results might also be improved by using Bayesian methods to estimate the expected as opposed to the observed probability that the end user would select R.

FIGS. 7 through 12 show a set of interface screens used for a client interface in one embodiment of the present invention. The interface screens shown are executed using the markup language HTML, or other suitable markup language for Web pages. The screen shown in FIG. 7 includes a host column 200 on the left-hand margin by which a host business provides the links and information allowing a client to navigate back to the host Web pages. The main body 201 of the page includes a request directory having a number of categories 202 through 207 in this example. The screen also includes a search tool 208 including a text input form by which a user enters keywords for searching the request directory. Along a top margin, a function bar 209 is included. The categories 202-207 correspond to category nodes in the database of FIGS. 6A through 6C.

When a user selects a category, such as category 202, of FIG. 7, the page shown in FIG. 8 is displayed. The page in FIG. 8 is similar to that of FIG. 7. However, it displays an intermediate level of categories in the request tree. Thus it includes categories 220-224.

In one embodiment of the present invention, the request tree is entered in context. Thus, if a client is shopping with the business for printers, then when the user enters the request tree browsing screens, a screen relevant to printers is brought up first. For example, the immediate level request category screen shown in FIG. 8 may be the first screen displayed based on the context from which the user entered the system. Other levels in the request tree, including screens showing request lists such as shown in the screen of FIG. 9, can be brought up based upon the context from which the user enters the system.

When a user selects a category, such as category 220, in the list of FIG. 8, the screen shown in FIG. 9 is displayed. The screen shown in FIG. 9 shows actual requests, by summary phrase, in a list 230. The list 230 includes check box forms, such as box 231, by which a user may indicate interest in the corresponding request. The screen of FIG. 9 also displays the search form 208, the menu bar 209 and the host column 200. A “submit” button 232 is included by which the user selections are submitted, and a link 233 by which a screen bringing out a tool for creating a new request is provided.

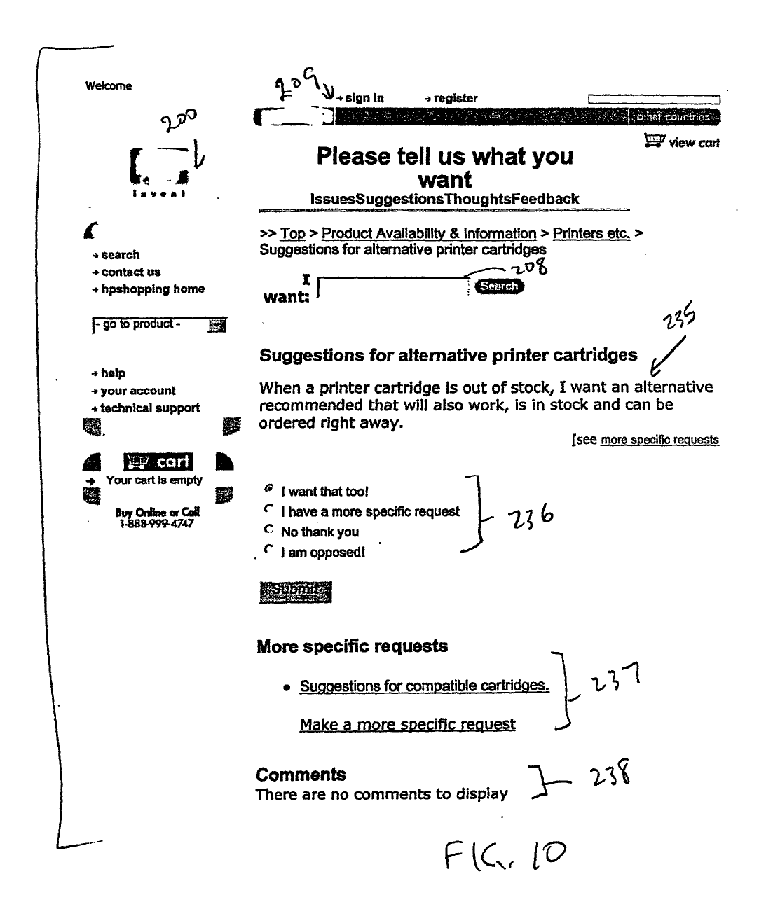

If the user selects a request, such as the first request in the list 230 of FIG. 9, the screen shown in FIG. 10 is displayed. In FIG. 10, the full text of the request 235 is displayed. Also, user input tool 236 is provided by which the user may provide an attitude concerning the request 235. More specific requests in request tree are also shown in the field 237. Any comments relating to the request are shown in the field 238. As part of the field 237, a link to a form for creating a more specific request is provided.

User selection of the link in field 237 in FIG. 10, and of the link 233 next to the submit button 232 in FIG. 9, result in display of a screen such as shown in FIG. 11. The screen shown in FIG. 11 provides a tool by which a user creates a request to be included the database. The tool includes a field 239 in which the user writes a description of the request. The form also includes a field 240 by which a user provides a brief summary of the request. A submit button 241 is included by which user indicates that the request being crafted is ready for submission to the business site.

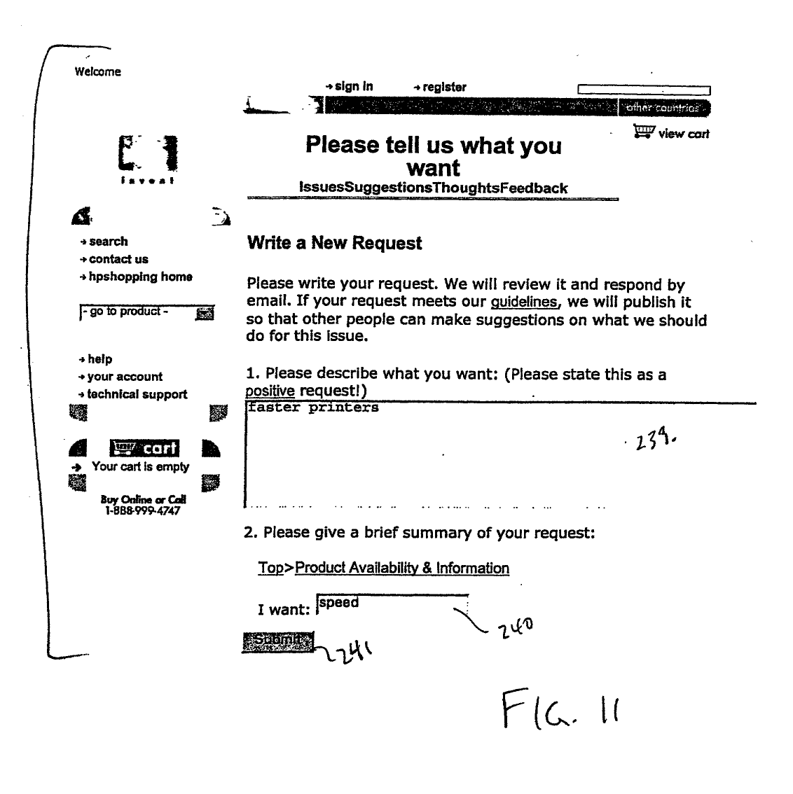

FIG. 12 illustrates a user sign-in form including fields 245 and 246 by which the user enters an email address and a password. This information, and possibly additional information about the user, is gathered to support communication with the user.

Thus using the screens of FIGS. 7-12, a client user is able to browse the request tree, and select particular requests. Further, the user is able to provide feedback about requests, and join in requests. Additionally, the user is able to create new requests.

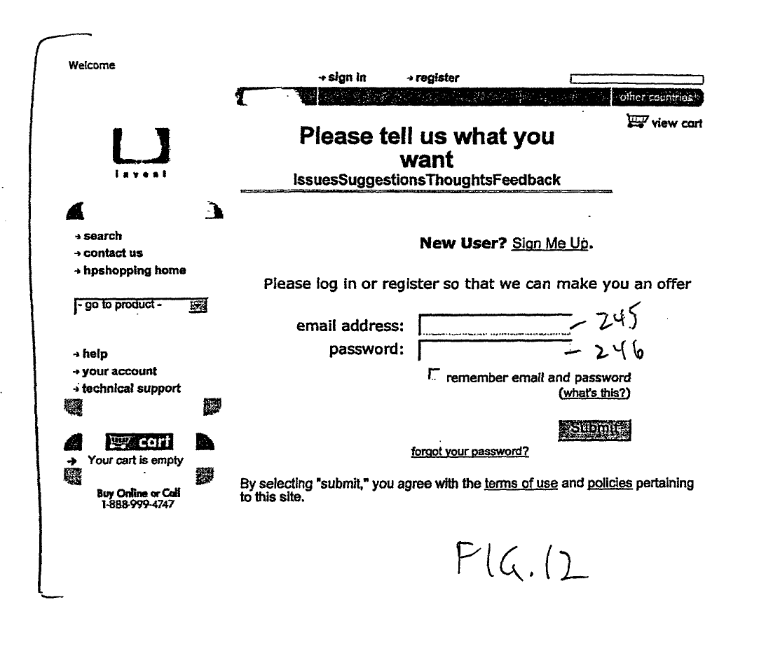

FIGS. 13-29 show examples of business user interface screens according to the present invention. FIG. 13 shows a top level request category screen for the business user interface. Thus the screen includes a menu bar 300 and a field 301 showing a plurality of request categories. With each request category in this example, a check box form, such as form 302, is included by which the business user may indicate desire to track the category. If the business user is tracking category, then the business user receives notifications and other information related to requests in the category.

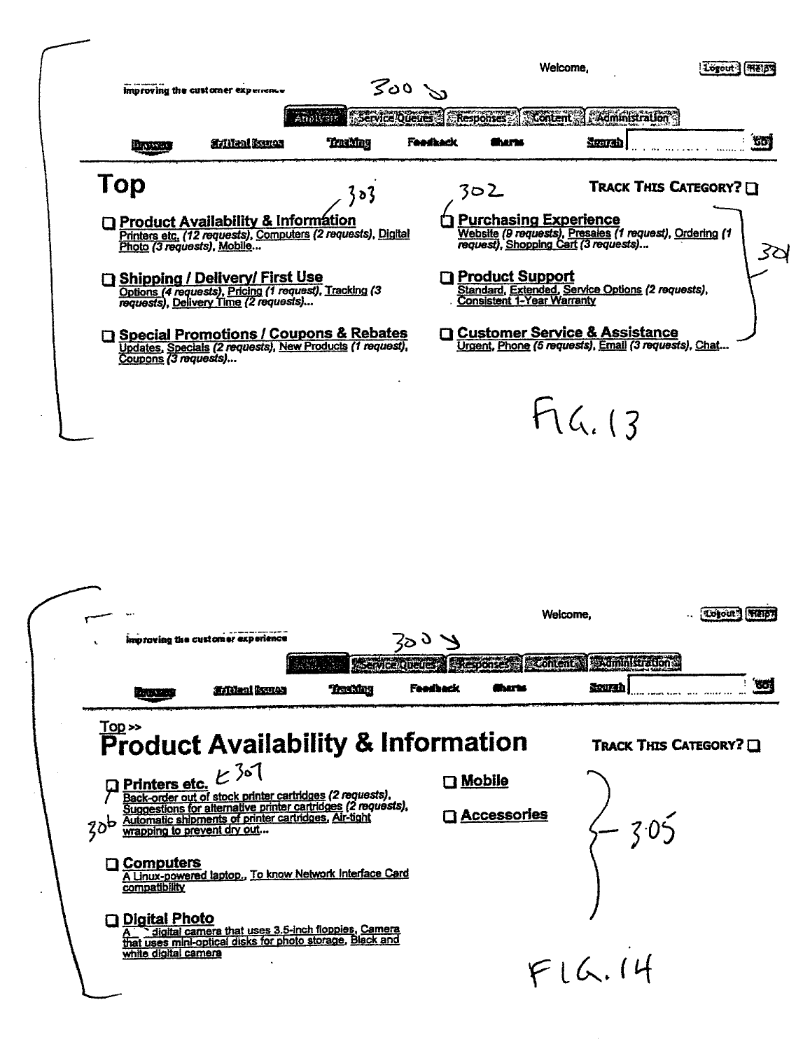

By selecting a category, such as category 303 in FIG. 13, the business user is presented with the display of FIG. 14. FIG. 14 includes an intermediate level of categories in field 305. Check boxes, such as check box 306 are included by which the business user may indicate a desire to track the category.

As can be seen, FIGS. 13 and 14 of the business user interface correspond roughly with FIGS. 7 and 8 in the client interface. This presents a unified data model to both client users and business users.

By selecting a category such as category 307 in the screen of FIG. 14, the screen in FIG. 15 is presented to the business user. The screen in FIG. 15 shows a list of requests along with parameters used for analysis of the corresponding requests. Thus, the list includes a column 310 by which characteristics of the requests are provided. For example, one characteristic which is indicated by entries in column 310 is whether the request is considered a hot topic according to parameters stored in the data model. In column 311, titles of the requests are provided. In this example, requests and sub-requests are shown, where sub-requests are indented and labeled with “L” symbols. In column 312, links to comments associated with the corresponding requests are provided. In column 313, the number of members that have joined in the request is indicated. In column 314, check boxes are provided indicating whether the business user is tracking the request, and allowing the business user to select requests to track. In column 315, the number of business users tracking the corresponding requests are shown.

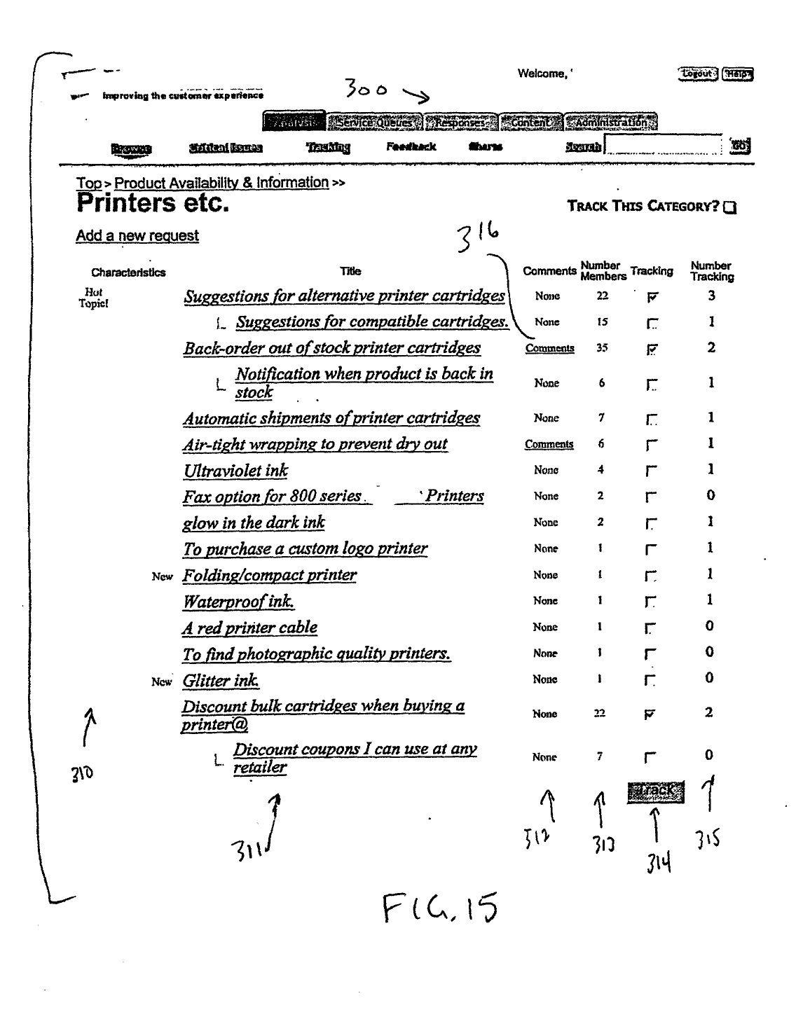

If the user selects the COMMENT link 316 which is associated with the request “Back-order out of stock printer cartridges,” then the screen of FIG. 16 is displayed. In FIG. 16, the text of comments associated with the request is provided in the field 320. The name of the person making the comment is provided in the field 321. Further, the attitude parameter associated with the person making the comment is shown in column 322.

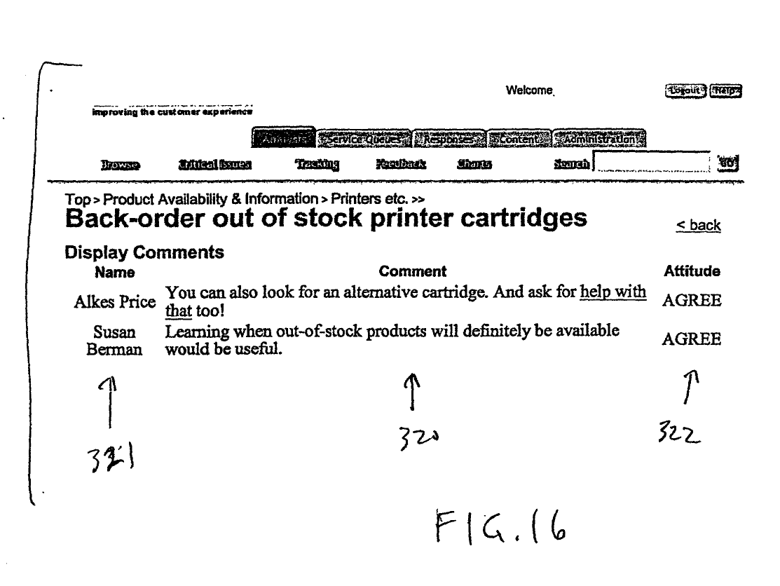

If from the screen of FIG. 15, the user selects request “Back order out of stock printer cartridges”, then the screen shown in FIG. 17 is displayed. The screen shown in FIG. 17 provides detail about the request used for analysis. Thus, the full text of the request is provided in field 330, the indicator of whether the request has been tagged as a “hot topic” is provided in field 331, a membership summary table 332 is provided. A chart 333 is provided which indicates the growth in number of members by date, along with the attitudes of the members using color coding. Further, the screen of FIG. 17 includes a field 335 which provides information about sub-requests of the request, and provides a link 336 by which the business user may enter a set of tool for creating a new request. Further, details concerning responses are provided in a field 337 along with a link 338 to a tool for making a new response.

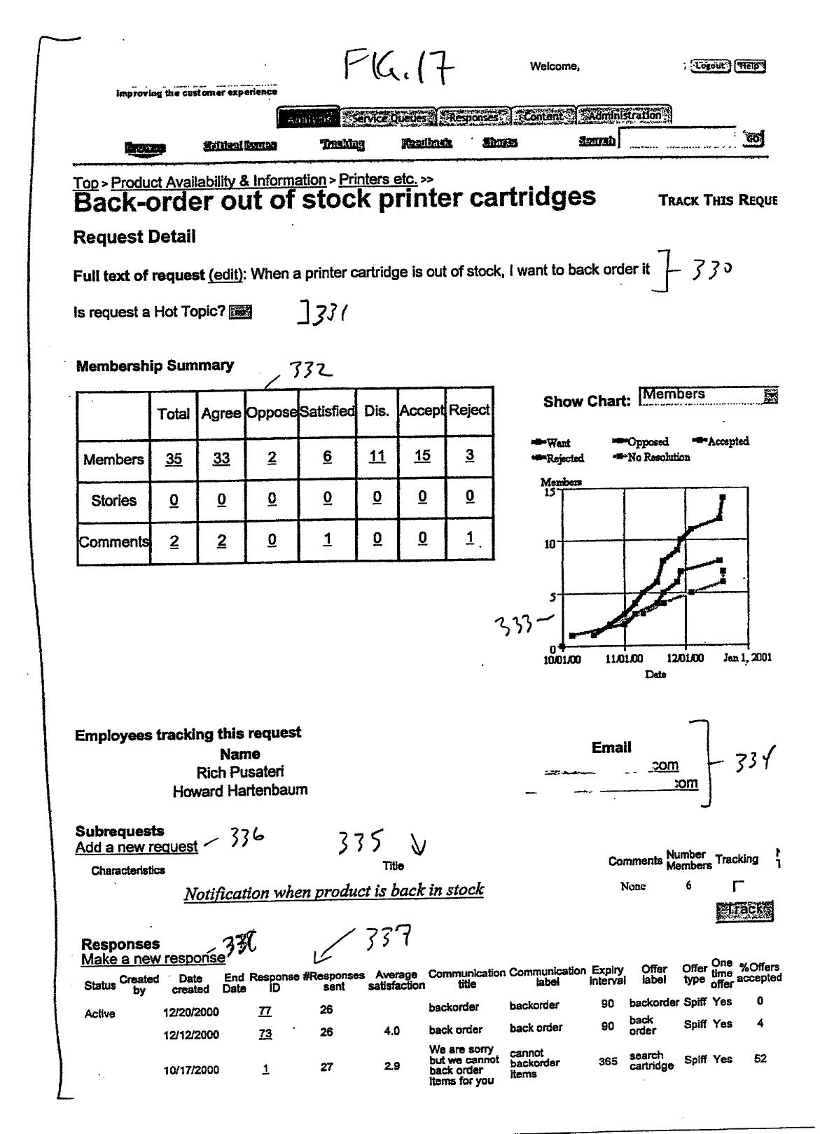

If in FIG. 17, the business user selects the link 338, then a set of screens is displayed to support creation of a new response. This example, there are five steps with corresponding screens displayed. In FIG. 18, step 1 of 5 for designing a response is provided. In the first field 340, the user indicates whether to make the response being created to sub-requests of the request, and a list of sub-requests is provided. The check box 341 is used for indicating whether sub-requests will receive the new response being created. Tools 342 are used for selecting a template to craft a communication supporting a response. Tool 343 is used for selecting a template used for creating a offer, if an offer is to be provided. Field 344 provides tools for a defining a type of response to whether it is a response indicated to provide an offer of a solution, or an offer of an incentive.

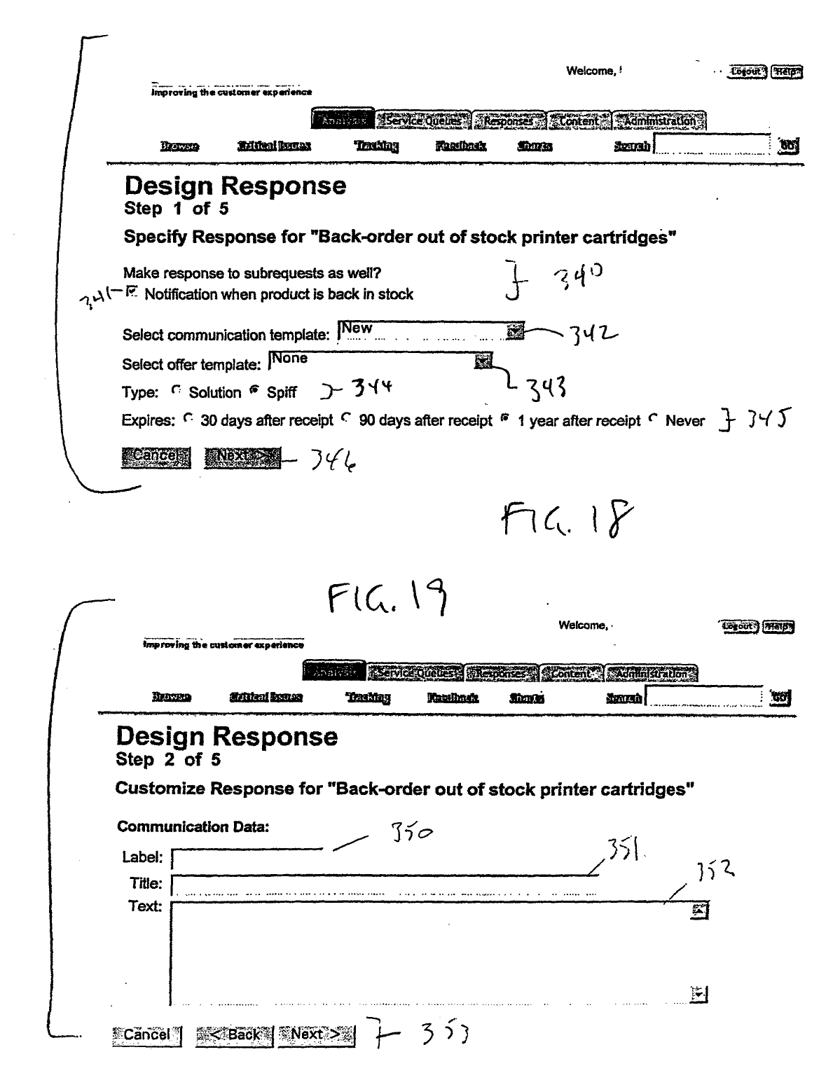

Field 345 presents options by which the user selects an expiration interval for the response. Upon completion of use of the tools provided the screen of FIG. 18, the user selects the “next” link 346. This brings up screen of FIG. 19 showing step 2 of the response design process. In step 2, field 350 is used to provide a label for the response used in the business interface for creating brief lists for analysis and tracking. Field 351 is used to provide a title for the response used in the client interface for identifying specific responses. Field 352 is used provide text for the response. The links in field 353 are used to back track, cancel to proceed to the next step.

FIG. 20 is entered if the user selects the “next” button in field 353 of FIG. 19. It shows step 3 out of five design response steps. In this screen, labels for communications and offers that make up the response are provided in field 355. Also a preview of the response as it will be shown to the clients when they access the request from the request tree is shown in field 356. As can be seen, the user is shown a response box with a label 357, text in field 358 including standard text from a template in the first line and newly entered text thereafter. A set of tools are provided in field 359 by which the user indicates a levels satisfaction with the response. Further, a tool is provided in field 360 by which the user is allowed to enter text for any comments associated with the response. A submit button 361 is included by which the user will initiate submission of a reply.

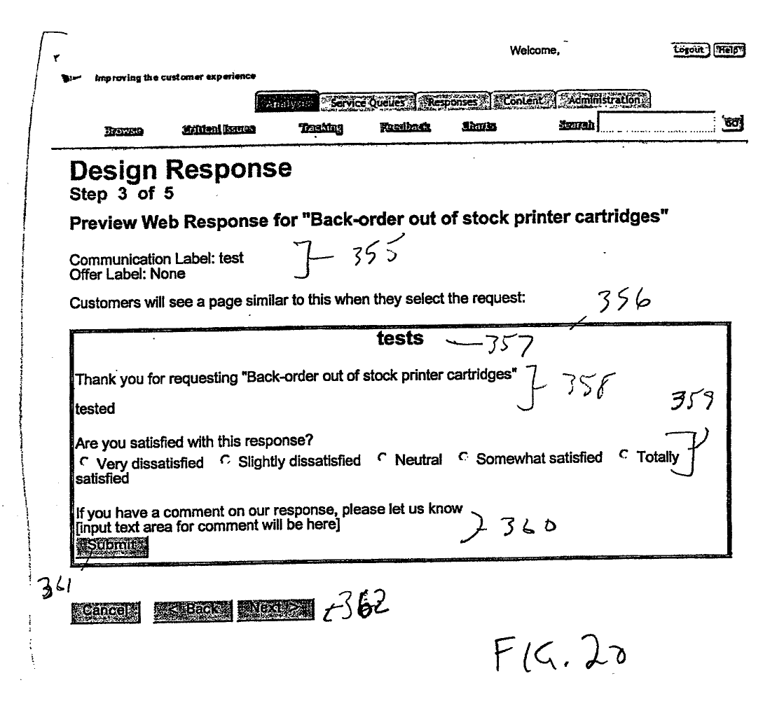

FIG. 21 is entered if the user selects the “next” button in field 362 of FIG. 20. In FIG. 21, the business user the shown a preview of an email message in field 365 which is sent to the group of customers who have already joined in this request. As can be seen, the email message includes links by which the user is enabled to make replies to the response.

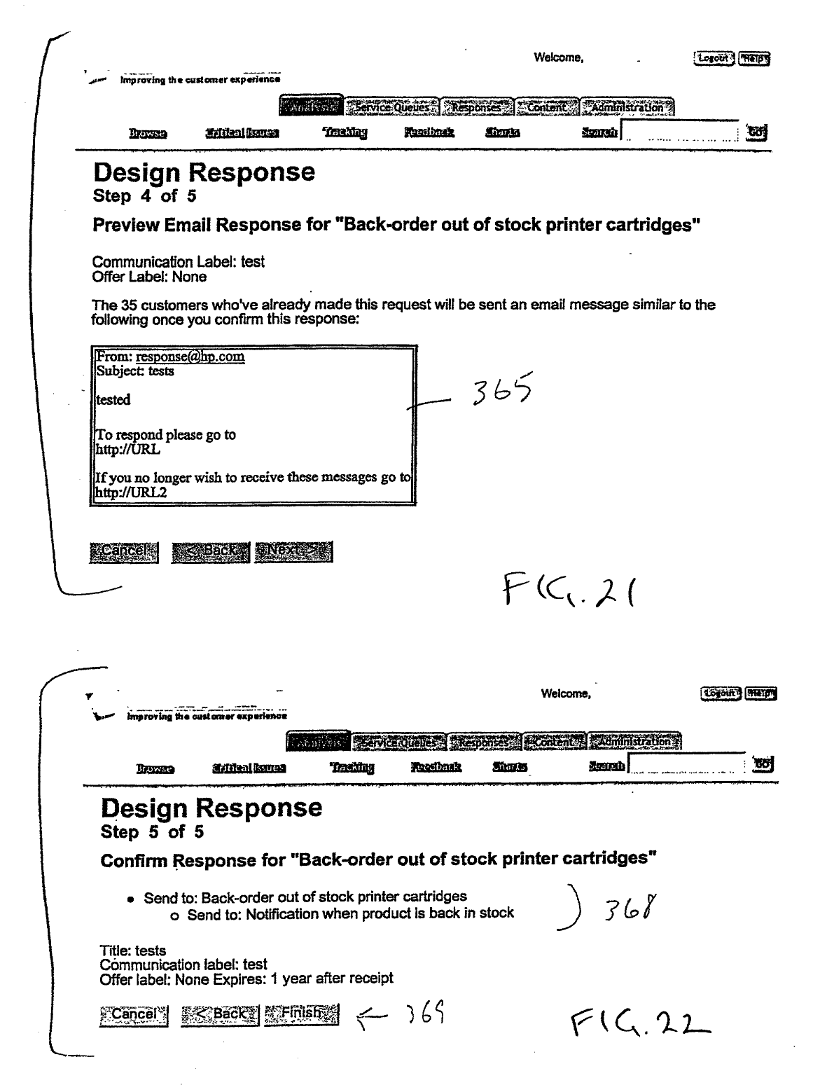

FIG. 22 shows the fifth step of five in the design response process. In the screen of FIG. 22, the user is asked to confirm the response created. Field 369 provides links by which the user is able to navigate back in the design response process, cancel the process, or to indicate that the process is finished. If the process is finished, and approved, a new response is added to the request data structure, and will be reflected in the field 337 of the screen in FIG. 17 by adding a new row corresponding to this new response. The response can be automatically “approved” if the user who creates it has appropriate authority.

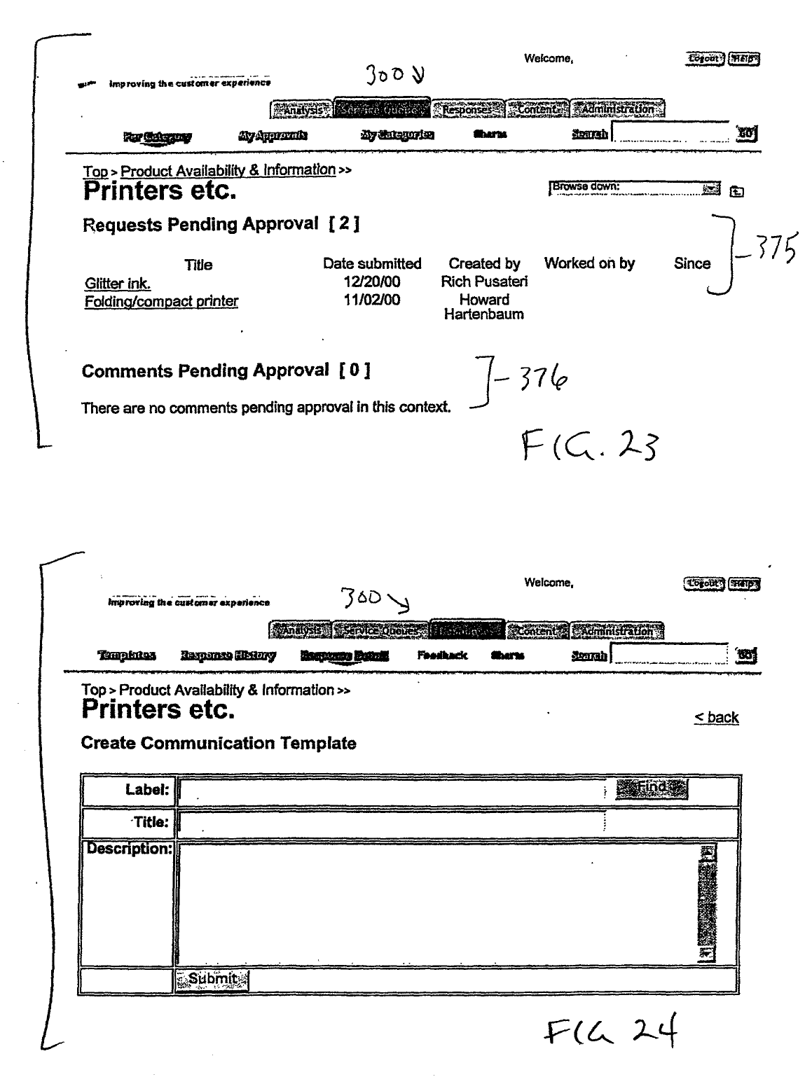

FIG. 23 shows a screen which is displayed in the user selects the tab “service queues” in the menu bar 300 of a business user interface screen. In this example, a product category is displayed along with a field 375 showing a list of requests pending approval and a field 376 showing a list of comments pending approval associated with this category. The business user may use this information to contact at person with authority to make the necessary approvals, or to manage the approvals to be made by the user himself or herself.

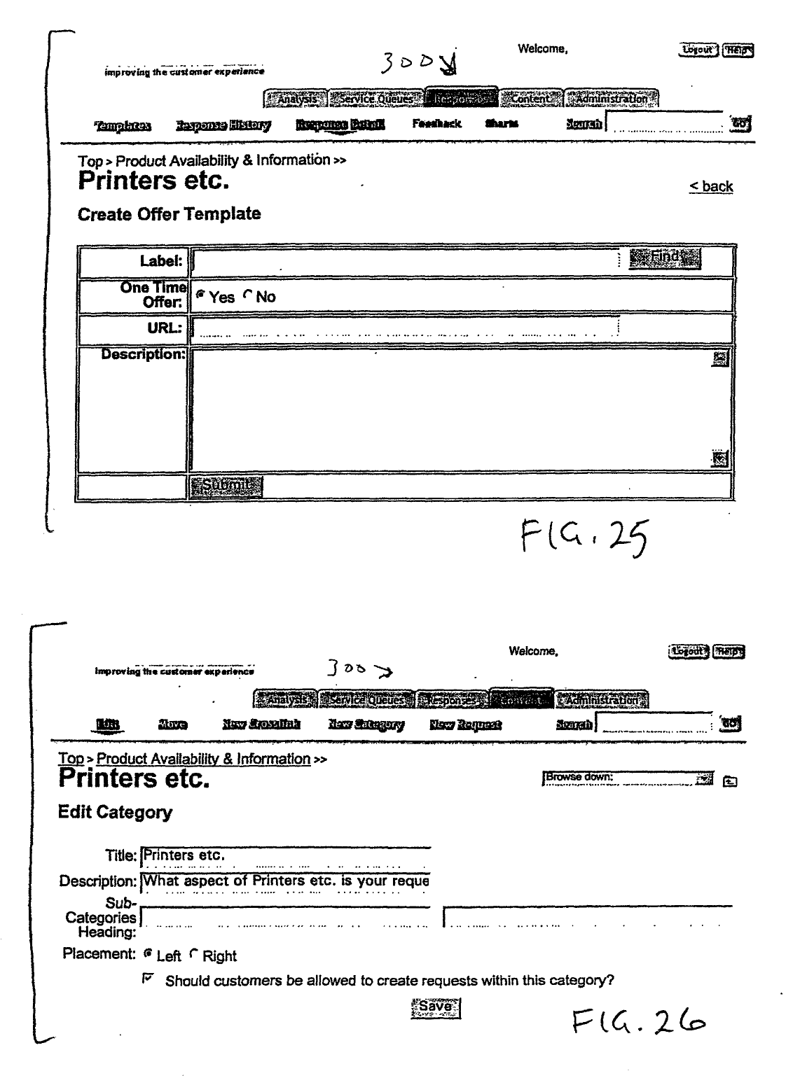

FIG. 24 shows a screen which is displayed with a user selects the tab “responses” in the menu bar 300 of the business user interface screens. FIG. 24 provides a communication template form to use by the business user.

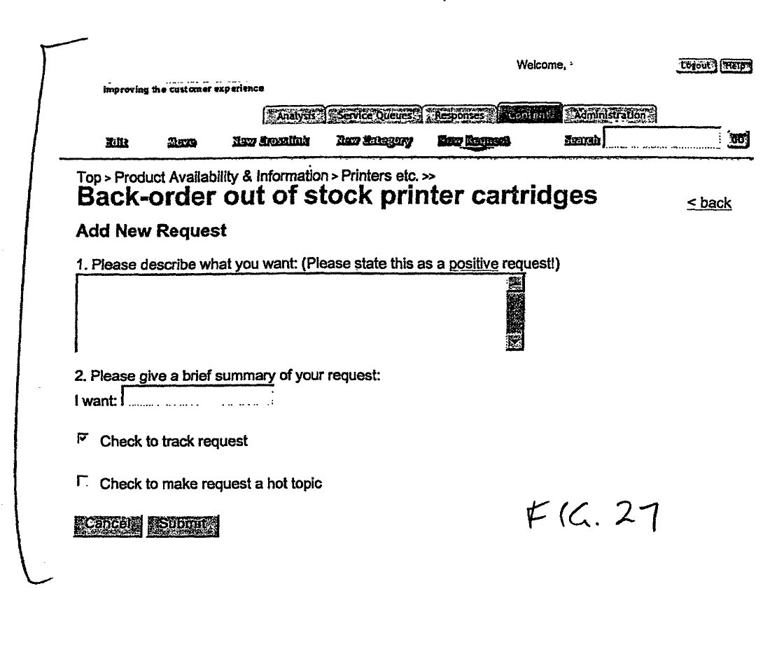

FIG. 25 is also accessed via the “responses” tab in the menu bar 300. In FIG. 25, a create offer template is provided to the business user.

FIG. 26 illustrates a screen of a business user interface which is accessed by selecting the tab “content” in the menu bar 300. Using this tool, the user is able to perform administrative tasks on the request tree, including editing requests and request categories, moving requests, creating crosslinks between request categories, creating new categories and new requests. In FIG. 26, a tool for editing a category is provided.

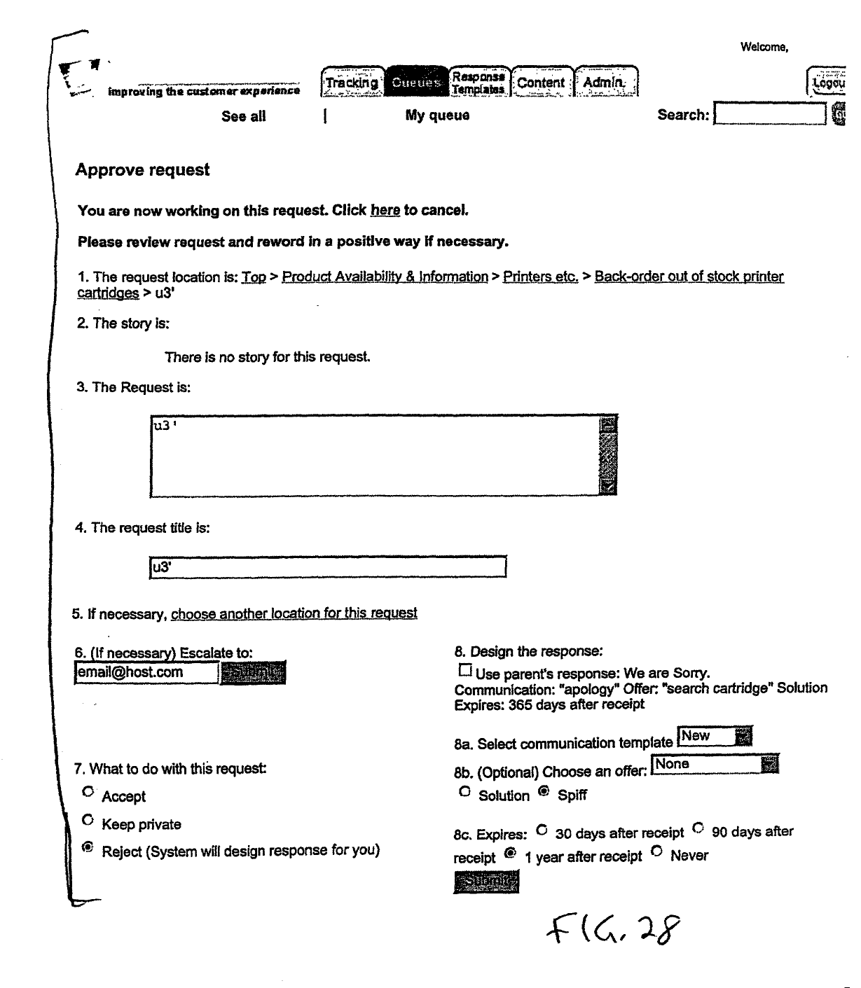

FIG. 27 shows a tool by which a business user is able to create a new request to be added to the request tree.

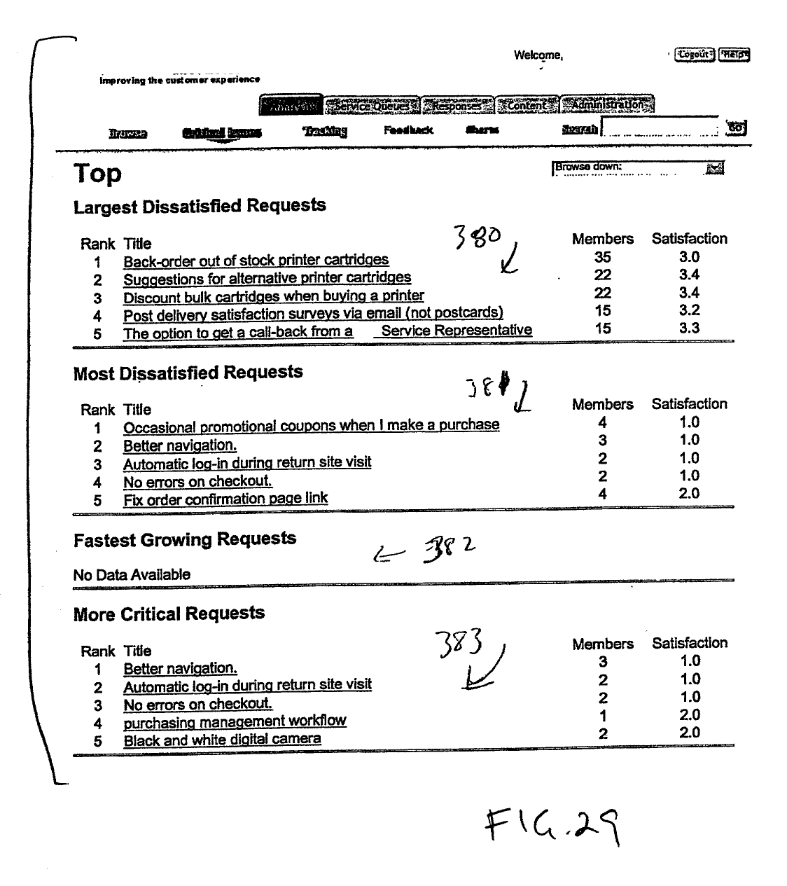

FIG. 28 shows a screen which is used for approving requests. Related screens are used for approving comments and responses. In this screen, a tool is provided by which details of the requests are reviewed and options associated with using the request in request tree are provided. Such options include expiration intervals, offer types, communication and offer templates to be utilized, and other information. From here, the business user is directed to the second step of the response process.

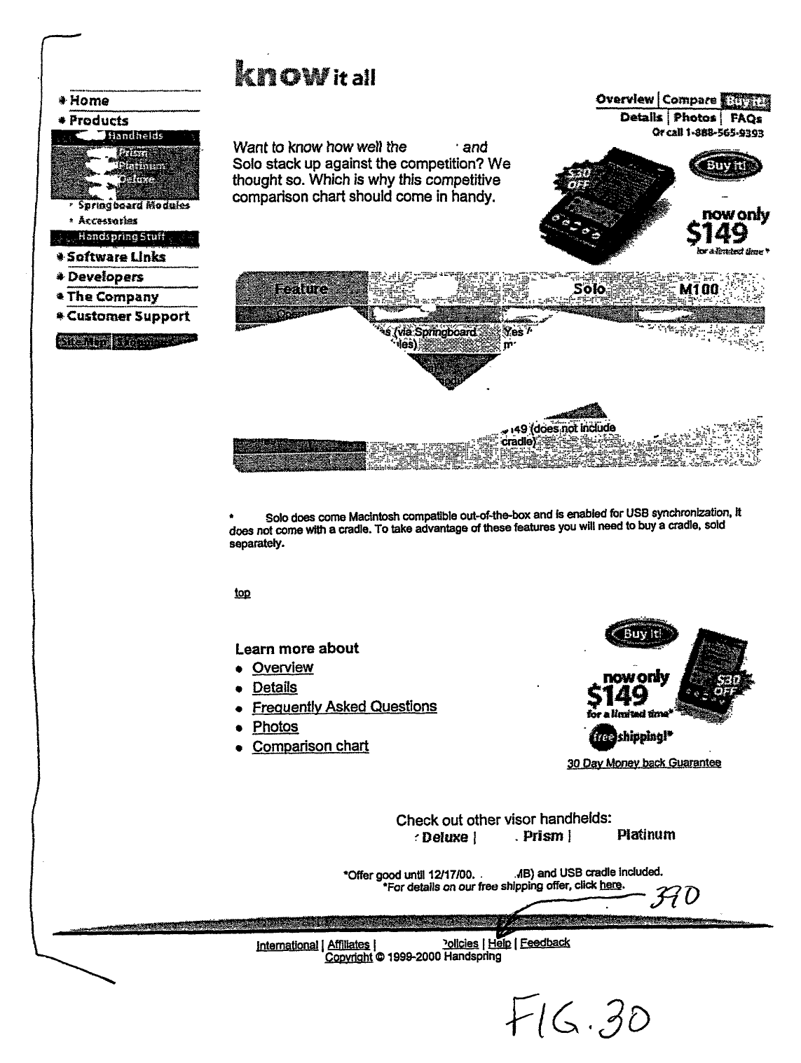

FIG. 29 shows an analysis screen for use by business users. This screen is based on analysis of the information gathered about requests in the request tree. The information in this screen is organized in field 380 by size and levels satisfaction indicated by replies to responses. Where the user is given option to selective five levels of satisfaction, an average between 0 and 1 is provided by the analysis tool. Field 381 ranks request groups by satisfaction level alone. Field 382 ranks request groups by rate of growth. Field 383 ranks request groups by a combination of these metrics. Thus analysis information is provided about the size of the group of associated with the request, the levels satisfaction, the rate of growth of requests, and critical requests.

FIGS. 30 and 31 illustrate screens encountered in the client interface when entering the request tree in context. In FIG. 30, a business web site screen is shown. In this example, the screen includes information used for making a decision about purchasing a hand held computer. At the bottom of the page, a “Help” link 390 is provided, which when selected, causes the client's browser to access the client interface of the system in context. Thus, for example, the screen shown in FIG. 31 appears as an entry point for the client to the request tree of the client interface. In this example, categories “Product” 391, “Sales” 392 and Web site” 393 are shown, along with sub-categories “Accessories” 394, “Springboard Modules” 395, “New Products” 396 and “Finding information” 397. In addition, requests “I want: Recharge option” 398, “I want: Flip cover” 399 and “I want: GPS/map module” 400 are displayed. The displayed categories, sub-categories, requests and sub-requests which are displayed are determined based upon metrics suggesting items in the tree likely to be viewed by clients entering from the screen of FIG. 30.

The screens shown in FIGS. 7-31 are examples, representative of a wide variety of screen formats and organizations which can be used according to the present invention.

Although customer-company interaction is the focus of the examples provided above, and constitutes one key aspect of the invention, the invention in a generic sense can be used in other applications.

One example is for a Call Center Application. The system can also be a method for CSR's in a call center, acting in the role corresponding to the client, to record requests on behalf of end users. This lets the company track requests across media and supports tighter integration between telephone and digital interactions with customers. For example, someone could raise an issue on the phone and, when the company resolves it three months later, receive email along with the people who selected the request inside the platform. This capability is particularly likely to be valuable for more challenging issues where only a few expert CSR's can provide a solution. In this case, the platform becomes a knowledge management application.

Another example is the Manufacturer—Reseller—Consumer channel. If both the manufacturer and reseller are clients, then the consumer should be able to resolve problems and make requests at either company's site, with the manufacturer's employees potentially doing the work even though the consumer thinks he or she is interacting with the reseller.

For complex industries like the personal computer, where any given problem can be the result of one or more of a dozen vendors, this concept can expand into an industry-wide support portal.

The platform can support Supplier—Company “B2B” Marketplaces. This is similar to the customer application except that suppliers are making requests instead of customers.

The platform can be used to facilitate communication between a company and its shareholders.

In general, the present invention provides a mechanism by which issues concerning, for example, a company'goods or services are identified using a tree of requests for action which is searchable by clients, and which can be expanded by client input. In addition, the invention provides a mechanism by which clients, for example customers of the company, that are connected with the issues are aggregated, using a group construct associating clients who join in selected requests for action. Further, the present invention provides tools by which resolution of the issues can be prioritized, and incentives related to, or solutions to, the issues can be efficiently distributed to the relevant customers in the form of responses, which may include offers, distributed on a group basis. With the present invention, the abilities to identify, to aggregate and to prioritize critical issues in complex environments, such as customer service, are significantly improved. Finally, information about customers' needs are efficiently distributed across a business, with each employee receiving information that is relevant to his or her responsibilities.

While the present invention is disclosed by reference to the preferred embodiments and examples detailed above, it is to be understood that these examples are intended in an illustrative rather than in a limiting sense. It is contemplated that modifications and combinations will readily occur to those skilled in the art which modifications and combinations will be within the spirit of the invention and the scope of the following claims.

What is claimed is:

1. A method comprising:
maintaining data about groups of persons, wherein the groups include persons associated with respective requests for action, the data including information sufficient to contact members of the groups;
providing a client interface for use of said data, by which users find and become members of the groups; and
providing a business user interface for use of said data, by which users monitor activity of groups and communicate with the groups.

2. The method of claim 1, wherein the client interface comprises a page accessible via the internet.

3. The method of claim 1, wherein the business user interface comprises a page accessible via the internet.

4. The method of claim 1, wherein the client interface includes tools for browsing a set of requests for action.

5. The method of claim 1, wherein the client interface includes tools for browsing a set of requests for action, selecting a particular request, and joining a group of persons associated with the particular request.

6. The method of claim 1, wherein the client interface includes a tool for composing and submitting a request for action.

7. The method of claim 1, wherein the client interface includes a tool for composing and submitting a comment associated with a selected request for action.

8. The method of claim 1, wherein the business user interface includes a tool for browsing a set of requests for action.

9. The method of claim 1, wherein the business user interface includes a tool for browsing a set of requests for action, selecting a particular request, and accessing information about a group of persons associated with the particular request.

10. The method of claim 1, wherein the business user interface includes a tool for composing and submitting a response to a particular request for action.

11. The method of claim 1, wherein the business user interface includes a tool for composing and submitting a response to a particular request for action, the response including an offer of a transaction directed to satisfaction of the request for action.

12. The method of claim 11, including a tool for providing the response to members of a group associated with the particular request.

13. The method of claim 12, wherein the response includes a tool by which a member of the group that receives the offer indicates acceptance or rejection of the offer.

14. The method of claim 12, wherein the response includes a tool by which a member of the group that receives the offer indicates a level of satisfaction with the offer.

15. The method of claim 1, including providing a system by which requests for action are approved by a person having authority, prior to being made visible in the client interface.

16. The method of claim 1, wherein the business user interface includes a tool for composing and submitting a response to a particular request for action, and including providing a system by which the response to the particular request is approved by a person having authority, and after approval, the response is sent to members of a group associated with the particular request prior to being sent to members of the group.

17. The method of claim 1, including providing a system by which comments associated with requests for action are approved by a person having authority, prior to being made visible in the client interface.

18. The method of claim 1, wherein said data comprises a node-link structure, including nodes for requests for action arranged in a hierarchy, the nodes for requests for action being linked with nodes for groups, which are linked with nodes for members of groups which are linked to nodes for responses submitted to groups.

19. The method of claim 1, including providing a user a response to a request for action in response to an event by which the user becomes a member of a particular group associated with the request for action.

20. The method of claim 1, wherein the client interface includes a tool allowing a user to indicate an attitude about a particular request for action, other than would be expressed solely by joining in the particular request for action.

21. The method of claim 1, wherein said client interface provides for displaying a page relating to requests for action determined based upon a context from which the user enters the client interface.

22. The method of claim 1, including providing a response to members of a group associated with a particular request for action, wherein the response includes an offer which can be accepted, and if the offer is accepted, then linking the member to a transactional page supporting satisfaction of the accepted offer.

23. The method of claim 1, wherein the business user interface includes a tool for composing and submitting a response to a particular request for action, including monitoring history of delivery of a particular response to users, and managing subsequent delivery of the particular response based on said history.

24. The method of claim 1, wherein the business user interface includes a tool for composing and submitting a response to a particular request for action, the response including a particular offer of a transaction directed to satisfaction of the request for action, and including monitoring history of delivery of the particular offer to users, and managing subsequent delivery of the particular offer based upon said history.

25. The method of claim 1, including organizing said requests for action according to a data model including categories for requests.

26. The method of claim 1, including organizing said requests for action according to a data model including categories and sub-categories for requests.

27. The method of claim 1, including organizing said requests for action according to a data model including categories for requests, and providing for notifying users of the business interface that have selected a particular category for tracking about events relevant to the particular category.

28. The method of claim 1, including organizing said requests for action according to a data model including categories for requests, and wherein said client interface provides for displaying a page including information about categories for requests determined based upon a context from which the user enters the client interface.

29. The method of claim 1, including providing for notifying users of the business interface that have selected a particular request for action for tracking, about events relevant to the particular request for action.

30. The method of claim 1, including organizing said requests for action according to a data model including categories for requests, and providing for indicating a selected category to be tracked by a particular user, and wherein the business interface includes a mechanism by which a particular user is presented information about said selected category.

31. The method of claim 1, including organizing said requests for action according to a data model including requests and sub-requests, and providing a response to a particular request for action also to a sub-request associated by the data model with the particular request for action.

32. The method of claim 1, including organizing said requests for action according to a data model including requests and sub-requests, and providing a response to a particular sub-request also to a request for action associated by the data model with the particular sub-request.

33. The method of claim 1, including organizing said requests for action according to a data model including requests and sub-requests.

34. A system comprising:
a data base including data about groups of persons, wherein the groups include persons associated with respective requests for action, the data including information sufficient to contact members of the groups;
a server coupled to a communication network, including:
resources to provide a client interface for use of said data via the communication network, by which users find and become members of the groups; and
resources to provide a business user interface for use of said data via the communication network, by which business users monitor activity of groups and communicate with the groups.

35. The system of claim 34, wherein the client interface comprises a page accessible via the internet.

36. The system of claim 34, wherein the business user interface comprises a page accessible via the internet.

37. The system of claim 34, wherein the client interface includes tools for browsing a set of requests for action.

38. The system of claim 34, wherein the client interface includes tools for browsing a set of requests for action, selecting a particular request, and joining a group of persons associated with the particular request.

39. The system of claim 34, wherein the client interface includes a tool for composing and submitting a request for action.

40. The system of claim 34, wherein the client interface includes a tool for composing and submitting a comment associated with a selected request for action.

41. The system of claim 34, wherein the business user interface includes a tool for browsing a set of requests for action.

42. The system of claim 34, wherein the business user interface includes a tool for browsing a set of requests for action, selecting a particular request, and accessing information about a group of persons associated with the particular request.

43. The system of claim 34, wherein the business user interface includes a tool for composing and submitting a response to a particular request for action.

44. The system of claim 34, wherein the business user interface includes a tool for composing and submitting a response to a particular request for action, the response including an offer directed to satisfaction of the request for action.

45. The system of claim 44, including a tool for providing the response to members of a group associated with the particular request.

46. The system of claim 45, wherein the response includes a tool by which a member of the group that receives the offer indicates acceptance or rejection of the offer.

47. The system of claim 45, wherein the response includes a tool by which a member of the group that receives the offer indicates a level of satisfaction with the offer.

48. The system of claim 34, including providing a system by which requests for action are approved by a person having authority, prior to being made visible in the client interface.

49. The system of claim 34, wherein the business user interface includes a tool for composing and submitting a response to a particular request for action, and including resources by which the response to the particular request is approved by a person having authority, and after approval, the response is sent to members of a group associated with the particular request prior to being sent to members of the group.

50. The system of claim 34, including resources by which comments associated with requests for action are approved by a person having authority, prior to being made visible in the client interface.

51. The system of claim 34, wherein said data comprises a node-link structure, including nodes for requests for action arranged in a hierarchy, the nodes for requests for action being linked with nodes for groups, which are linked with nodes for members of groups which are linked to nodes for responses submitted to groups.

52. The system of claim 34, including resources to provide a user a response to a request for action in response to an event by which the user becomes a member of a particular group associated with the request for action.

53. The system of claim 34, wherein the client interface includes a tool allowing a user to indicate an attitude about a particular request for action, other than would be expressed solely by joining in the particular request for action.

54. The system of claim 34, wherein said client interface includes a tool for displaying a page relating to requests for action determined based upon a context from which the user enters the client interface.

55. The system of claim 34, including resources providing a response to members of a group associated with a particular request for action, wherein the response includes an offer which can be accepted, and if the offer is accepted, then linking the member to a transactional page supporting satisfaction of the accepted offer.

56. The system of claim 34, wherein the business user interface includes a tool for composing and submitting a response to a particular request for action, including resources monitoring history of delivery of a particular response to users, and managing subsequent delivery of the particular response based on said history.

57. The system of claim 34, wherein the business user interface includes a tool for composing and submitting a response to a particular request for action, the response including a particular offer of a transaction directed to satisfaction of the request for action, and including resources monitoring history of delivery of the particular offer to users, and managing subsequent delivery of the particular offer based upon said history.

58. The system of claim 34, wherein said database organizes said requests for action according to a data model including categories for requests.

59. The system of claim 34, wherein said database organizes said requests for action according to a data model including categories and sub-categories for requests.

60. The system of claim 34, wherein said database organizes said requests for action according to a data model including categories for requests, and including resources providing for notifying users of the business interface that have selected a particular category for tracking about events relevant to the particular category.

61. The system of claim 34, wherein said database organizes said requests for action according to a data model including categories for requests, and wherein said client interface provides for displaying a page including information about categories for requests determined based upon a context from which the user enters the client interface.

62. The system of claim 34, including resources providing for notifying users of the business interface that have selected a particular request for action for tracking, about events relevant to the particular request for action.

63. The system of claim 34, wherein said database organizes said requests for action according to a data model including categories for requests, and including resources providing for indicating a selected category to be tracked by a particular user, and wherein the business interface includes a mechanism by which a particular user is presented information about said selected category.

64. The system of claim 34, wherein said database organizes said requests for action according to a data model including requests and sub-requests, and including resources providing a response to a particular request for action also to a sub-request associated by the data model with the particular request for action.

65. The system of claim 34, wherein said database organizes said requests for action according to a data model including requests and sub-requests, and including resources providing a response to a particular sub-request also to a request for action associated by the data model with the particular sub-request.

66. The system of claim 34, wherein said database organizes said requests for action according to a data model including requests and sub-requests.

67. An article of manufacture comprising:
a machine readable data storage medium storing computer program instructions, which upon execution establish a data base including data about groups of persons, wherein the groups include persons associated with a request for action, the data including information sufficient to contact members of the groups; and
resources to provide a client interface for use of said data via the communication network, by which users find and become members of the groups; and
resources to provide a business user interface for use of said data via the communication network, by which business users monitor activity of groups and communicate with the groups.

68. The article of claim 67, wherein the client interface comprises a page accessible via the internet.

69. The article of claim 67, wherein the business user interface comprises a page accessible via the internet.

70. The article of claim 67, wherein the client interface includes tools for browsing a set of requests for action.

71. The article of claim 67, wherein the client interface includes tools for browsing a set of requests for action, selecting a particular request, and joining a group of persons associated with the particular request.

72. The article of claim 67, wherein the client interface includes a tool for composing and submitting a request for action.

73. The article of claim 67, wherein the client interface includes a tool for composing and submitting a comment associated with a selected request for action.

74. The article of claim 67, wherein the business user interface includes a tool for browsing a set of requests for action.

75. The article of claim 67, wherein the business user interface includes a tool for browsing a set of requests for action, selecting a particular request, and accessing information about a group of persons associated with the particular request.

76. The article of claim 67, wherein the business user interface includes a tool for composing and submitting a response to a particular request for action.

77. The article of claim 67, wherein the business user interface includes a tool for composing and submitting a response to a particular request for action, the response including an offer directed to satisfaction of the request for action.

78. The article of claim 77, wherein the computer program instructions include a tool for providing the response to members of a group associated with the particular request.

79. The article of claim 78, wherein the response includes a tool by which a member of the group that receives the offer indicates acceptance or rejection of the offer.

80. The article of claim 78, wherein the response includes a tool by which a member of the group that receives the offer indicates a level of satisfaction with the offer.

81. The article of claim 67, wherein the computer program instructions include resources by which requests for action are approved by a person having authority indicated in the data, prior to being made visible in the client interface.

82. The article of claim 67, wherein the business user interface includes a tool for composing and submitting a response to a particular request for action, and wherein the computer program instructions include resources providing a system by which the response to the particular request is approved by a person having authority indicated in the data, and after approval, the response is sent to members of a group associated with the particular request prior to being sent to members of the group.

83. The article of claim 67, wherein the computer program instructions include a system by which comments associated with requests for action are approved by a person having authority indicated in the data, prior to being made visible in the client interface.

84. The article of claim 67, wherein said data comprises a node-link structure, including nodes for requests for action arranged in a hierarchy, the nodes for requests for action being linked with nodes for groups, which are linked with nodes for members of groups which are linked to nodes for responses submitted to groups.

85. The article of claim 67, wherein the computer program instructions include logic to provide a user a response to a request for action in response to an event by which the user becomes a member of a particular group associated with the request for action.

86. The article of claim 67, wherein the client interface includes a tool allowing a user to indicate an attitude about a particular request for action, other than joining in the particular request for action.

87. The article of claim 67, wherein said client interface provides for displaying a page relating to said requests for action determined based upon a context from which the user enters the client interface.

88. The article of claim 67, wherein the computer program instructions include logic to provide a response to members of a group associated with a particular request for action, wherein the response includes an offer which can be accepted, and if the offer is accepted, then linking the member to a transactional page supporting satisfaction of the accepted offer.

89. The article of claim 67, wherein the business user interface includes a tool for composing and submitting a response to a particular request for action, the computer program instructions including logic to monitor history of delivery of a particular response to users, and managing subsequent delivery of the particular response based on said history.

90. The article of claim 67, wherein the business user interface includes a tool for composing and submitting a response to a particular request for action, the response including a particular offer of a transaction directed to satisfaction of the request for action, the computer program instructions including logic to monitor history of delivery of the particular offer to users, and to manage subsequent delivery of the particular offer based upon said history.

91. The article of claim 67, wherein said database organizes said requests for action according to a data model including categories for requests.

92. The article of claim 67, wherein said database organizes said requests for action according to a data model including categories and sub-categories for requests.

93. The article of claim 67, wherein said database organizes said requests for action according to a data model including categories for requests, and the computer program instructions include logic to provide for notifying users of the business interface that have selected a particular category for tracking about events relevant to the particular category.

94. The article of claim 67, wherein said database organizes said requests for action according to a data model including categories for requests, and wherein said client interface provides for displaying a page including information about categories for requests determined based upon a context from which the user enters the client interface.

95. The article of claim 67, the computer program instructions including logic to provide for notifying users of the business interface that have selected a particular request for action for tracking about events relevant to the particular request for action.

96. The article of claim 67, wherein said database organizes said requests for action according to a data model including categories for requests, and the computer program instructions include logic to provide for indicating a selected category to be tracked by a particular user, and wherein the business interface includes a mechanism by which a particular user is presented information about said selected category.

97. The article of claim 67, wherein said database organizes said requests for action according to a data model including requests and sub-requests, and the computer program instructions including logic to provide a response to a particular request for action also to a sub-request associated by the data model with the particular request for action.

98. The article of claim 67, wherein said database organizes said requests for action according to a data model including requests and sub-requests, and the computer program instructions include logic to provide a response to a particular sub-request also to a request for action associated by the data model with the particular sub-request.

99. The article of claim 67, wherein said database organizes said requests for action according to a data model including requests and sub-requests.

100. A method comprising:
maintaining data about groups of persons, wherein the groups include persons associated with a request for action, the data including information sufficient to contact members of the groups;
presenting an interface to a network, the interface including an information model by which users of the interface find and become members of one or more of the groups;
providing tools to users in the network by which requests for action are approved for use in formation of a group;
providing a response to members of a particular group based on the request for action associated with the particular group, the response including an offer of a transaction directed to satisfaction of the request for action; and
providing tools to members in the particular group that view the response to indicate acceptance of the offer in the response.

101. The method of claim 100, including:
providing a tool by which users track events relevant to a selected group.

102. The method of claim 100, wherein the tool by which users track events include a screen on which information about activity of the selected group are presented for analysis.

103. The method of claim 100, including a tool to direct members that indicate acceptance of the offer to a transactional page supporting satisfaction of the accepted offer.

104. A method comprising:
maintaining data about groups of persons, wherein the groups include persons associated with a request for action, the data including information sufficient to contact members of the groups; and
providing a client interface for use of said data, by which users find and become members of the groups.

105. The method of claim 104, wherein the client interface comprises a page accessible via the internet.

106. The method of claim 104, wherein the client interface includes tools for browsing a set of requests for action.

107. The method of claim 104, wherein the client interface includes tools for browsing a set of requests for action, selecting a particular request, and joining a group of persons associated with the particular request.

108. The method of claim 104, wherein the client interface includes a tool for composing and submitting a request for action.

109. The method of claim 104, wherein the client interface includes a tool for composing and submitting a comment associated with a selected request for action.
